(19) United States
(12) Patent Application Publication
(10) Pub. No.: US 2014/0256331 A1
(43) Pub. Date: Sep. 11, 2014

(54) WIRELESS COMMUNICATION SYSTEM AND WIRELESS COMMUNICATION METHOD AND BASE STATION DEVICE

(71) Applicants: Hiroto Adachi, Tokyo (JP); Mikio Kuwahara, Tokyo (JP); Hajime Kanzaki, Tokyo (JP)

(72) Inventors: Hiroto Adachi, Tokyo (JP); Mikio Kuwahara, Tokyo (JP); Hajime Kanzaki, Tokyo (JP)

(73) Assignee: HITACHI, LTD., Tokyo (JP)

(21) Appl. No.: 14/241,661

(22) PCT Filed: Aug. 16, 2012
(86) PCT No.: PCT/JP2012/070809

§ 371 Date: Mar. 5, 2014

(30) Foreign Application Priority Data
Sep. 22, 2011 (JP) 2011-206727
Oct. 21, 2011 (JP) 2011-231256

(51) Int. Cl. H04W 16/06; H04L 5/00; H04W 88/08

(52) U.S. Cl. CPC H04W 16/06; H04W 88/08; H04L 5/0073
USPC 455/447; 455/561

(57) ABSTRACT

Information is exchanged among multiple base stations by adaptively changing an allocation of radio resource of each base station, and reducing deterioration in a signal quality that is caused by interference of signals transmitted from multiple base stations. Communication with a terminal located in a cell center and communication with a terminal located in a cell edge are performed in different time zones. In addition, communication is performed such that time zones do not overlap in the cell edge between multiple neighbor base station devices. In addition, efficiency that is an index representing the number of bits transmittable per resource element is calculated using a scanning result of a terminal, and one base station that decides a radio resource allocation between cells decides radio resources to be allocated to a terminal located in a cell center and radio resources to be allocated to the cell edge using the efficiency information.

This application claims the benefit of Japanese Priority Patent Application JP 2011-206727 filed on Sep. 22, 2011, and Japanese Priority Patent Application JP 2011-231256 filed on Oct. 21, 2011, the entire contents of each of which are incorporated herein by reference.

### TECHNICAL FIELD

The present invention relates to a wireless communication technique, and more particularly, a technique of reducing interference of signals transmitted from multiple base stations in an edge area among multiple base stations.

### BACKGROUND ART

1. Cellular Wireless Communication System

In mobile wireless communication system, a cellular scheme is commonly employed to form a service area extending as a plane and provide a wireless communication service. In the cellular scheme, a planar service area is implemented such that multiple base stations is dotted to splice coverage areas (areas in which a radio wave transmitted from the base station reaches and communication with a terminal is possible) of the base stations in an area in which a wireless communication service is desired to be provided.

FIG. 1 is a diagram illustrating an example of a cellular wireless communication system.

The cellular wireless communication system includes multiple base stations 1-1, 1-2, and the like and multiple terminals 10-1, 10-2, and the like. In FIG. 1, the terminals 10-1, 10-2, 10-3, and 10-4 perform wireless communication with the base station 1-1. The base stations 1-1, 1-2, and the like are connected to a network device 20 and secure a communication channel with a wired network. In FIG. 1, the base station 1-1 is closest in distance to the terminal 10-1, and the terminal 10-1 can receive a good signal from the base station 1-1 and thus performs communication with the base station 1-1.

The base stations 1-1, 1-2, and the like transmit a reference signal (or a preamble signal) serving as a recognition signal causing the terminals to recognize the base station to the terminals. The reference signal is designed to have a transmission signal sequence differing according to each base station or to be unique to a certain area in a transmission time, or a communication frequency, or a combination of the signal sequence, the time, and the frequency. The terminals 10-1, 10-2, and the like receive the unique reference signals transmitted from the base stations 1-1, 1-2, and the like, measure and compare reception levels of the respective reference signals, and detect radio states between the terminal and a currently connected base station and between the terminal and multiple neighbor base stations. The terminals 10-1, 10-2, and the like determine that the base station that is highest in the reception level of the reference signal is the closest base station. When the terminal determines that the base station having the highest reception level (that is, having the best reception state) has changed from the currently connected base station to the neighbor base station, a handover of switching a connection to a base station from which a better reception state can be expected is performed.

FIG. 1 illustrates a downlink (communication from a base station to a terminal) signal A and an uplink (communication from a terminal to a base station) signal B in connection with the base station 1-1. The base station 1-2 transmits a downlink signal C. Here, since the base stations 1-1 and 1-2 transmit the signal at the same frequency and the same time, the downlink signals A and C are likely to interfere with each other. The terminal 10-1 located in a cell edge receives the desired signal A transmitted from the base station 1-1, but simultaneously receives the signal C transmitted from the base station 1-2 as well. Thus, the signal C serves as an interference wave, and influences the terminal 10-1. A ratio of interference power and noise power to desired signal power is called a signal to interference and noise power ratio (SINR), and calculated by desired signal power/(interference power+noise power). In the cell edge, interference from other cells other than a connected base station comes strong, and the interference power value in the denominator becomes a dominant term. Thus, the SINR deteriorates, and it is difficult to transmit information at a high throughput.

2. 4G Mobile Wireless Communication System

In recent years, technology development of the 4G mobile wireless communication system (IMT-Advanced) has been actively conducted. As IMT-Advanced, there are LTE-Advanced being discussed in the standardization organization 3GPP and IEEE 802.16m being discussed in the IEEE. In such communication schemes, broadband transmission is implemented using frequency bands that are not used in communication schemes of the related art. In addition, as a multi-input multi-output (MIMO) scheme and an orthogonal frequency division multiplexing access (OFDMA) scheme are applied, a transmission signal is subjected to spatial multiplexing and then transmitted to multiple users, and a restricted frequency band is shared by multiple users, and thus a high frequency utilization efficiency is realized.

In the OFDMA applied in the 4G generation mobile wireless communication system, resource units (or resource blocks) are formed by dividing a frequency into multiple sub carriers and bringing multiple consecutive sub carriers on the frequency axis together into several consecutive OFDM symbols on the time axis using a fast Fourier transform (FFT). In IEEE802.16m, an operation called permutation is performed on the formed resource units to rearrange the resource unit order. The resource unit rearranging method by the permutation differs according to each base station.

Each base station causes the terminal to occupy radio resources in units of resource units by scheduling and then performs communications. For this reason, within the same cell, only one terminal can use a certain resource unit (or resource block) unless multi user MIMO (MU-MIMO) transmission is performed, and except in the case of MU-MIMO, interference does not occur within a base station in communication using the same resource unit.

3. Fractional Frequency Reuse (FFR) As a method of reducing interference in the cell edge or the sector edge, a FFR is known. For example, NPTL 1 discloses an interference reduction method using the FFR in IEEE 802.16m.

FIG. 2 is a diagram for describing a frequency using method of a base station when the FFR is applied. In FIG. 2, a horizontal axis represents a frequency, and a vertical axis represents transmission power. In the FFR, influence of interference from a neighbor base station is reduced by dividing a frequency band into multiple partitions (four partitions of partitions 0 to 3 in the example of FIG. 2) and increasing a transmission output and desired signal power that is the numerator of the SINR in a frequency of a certain partition as illustrated in FIG. 2. In addition, by decreasing the transmission power and interference on a neighbor base station which is the denominator of the SINR in a frequency of another partition, the throughput of a terminal having access to the neighbor base station in the cell edge or the sector edge is improved.

Although transmission power of a frequency of a certain partition is reduced as described above, when the terminal performing communication using the frequency is located near the base station, influence of interference from the neighbor base station is small, and it is possible to perform communication even at low transmission power. As described above, the FFR is a technique of reducing inter-cell interference by dividing a frequency into multiple partitions, increasing or decreasing transmission power, and using different transmission power.

FIG. 3 is a diagram illustrating three neighbor base stations.

An example of a method of reducing inter-cell interference by the FFR will be described with reference to FIG. 3.

In FIG. 3, each of three base stations 1-1, 1-2, and 1-3 forms a cell, and performs the FFR. Here, the base station 1-1 is assumed to use a the pattern 1 of FIG. 2, the base station 1-2 is assumed to use a pattern 2 of FIG. 2, and the base station 1-3 is assumed to use a pattern 3 of FIG. 2.

The base station 1-1 allocates partitions 50, 52-1, and 53-1 illustrated in FIG. 2 to a terminal located in an area 60 serving as the cell center. However, the partitions 52-1 and 53-1 are allocated to a terminal closer to the cell center in the area 60. Meanwhile, the base station 1-1 allocates a partition 51-1 illustrated in FIG. 2 to a terminal located in an area 61 serving as the cell edge. Similarly, the neighbor base station 1-2 allocates partitions 50, 51-2, and 53-2 indicated by the pattern 2 of FIG. 2 to a terminal located in an area 62 serving as the cell center (allocates the partitions 51-2 and 53-2 to a terminal closer to the cell center), and allocates a partition 52-2 indicated by the pattern 2 of FIG. 2 to a terminal located in a cell edge area 63.

In addition, the neighbor base station 1-3 allocates partitions 50, 51-3, and 52-3 indicated by the pattern 3 of FIG. 2 to a terminal located in an area 64 serving as the cell center (allocates the partitions 51-3 and 52-3 to a terminal closer to the cell center), and allocates a partition 53-3 indicated by the pattern 3 of FIG. 2 to a terminal located in a cell edge area 65.

Referring to the cell edges indicated by the areas 61, 63, and 65, the partition 51-1 is used in the area 61, the partition 52-2 is used in the area 63, and the partition 53-3 is used in the area 65, and thus the same partition is not used at high transmission power between neighbor base stations. As described above, what different frequencies are used between neighbor cells or sectors is expressed to be orthogonal. Using the FFR, since frequencies allocated to the cell edge between neighbor base stations are orthogonal, influence of interference is significantly reduced.

4. Inter-Cell Interference Coordination (ICIC)

The ICIC is a technique of reducing interference in the cell edge or the sector edge by exchanging information such as interference among multiple neighbor base stations and restricting a frequency and power to be used by the base stations.

FIG. 4 is a diagram illustrating a concept of the ICIC.

As illustrated in FIG. 4, the ICIC is performed not only such that base stations belonging to different cells exchange information with each other, and cells perform control of interference in collaboration with each other, but also such that base stations configuring sectors in the same cell exchange information with each other, and sectors perform control of interference in collaboration with each other.

FIG. 5 is a diagram for describing a frequency using method of a base station when the ICIC is applied.

In FIG. 5, a horizontal axis represents a frequency, and a vertical axis represents transmission power.

In the FFR, since it is not performed to exchange information between base stations and restrict a frequency or power to be used by the base stations, the partition size or the frequency bandwidth are the same and have a fixed size on a system as illustrated in FIG. 2.

Meanwhile, in the ICIC, the base stations exchange information such as interference and concede a frequency or power to be used by the base stations, and thus it is possible to change the size of the frequency bandwidth of Partitions 81 to 83, for example, according to an interference state or a load of each base station. Thus, the ICIC can realize the high system throughput compared to the FFR. However, in order to perform the ICIC, the base stations need to be the same in the arrangement order of the resource unit (or resource block). For this reason, in a wireless communication system in which a different permutation operation is performed according to each base station, the base stations performing the ICIC need to be the same in the resource unit arrangement method by the permutation.

As a concrete method of controlling interference between base stations using the ICIC, there is the following method. First, several to tens of neighbor base stations that desire to perform control by the ICIC are divided into groups. Then, a single base station that concentratedly controls all groups is decided. Then, various kinds of information such as interference or the SINR of each terminal acquired by each base station of a control target is gathered to the single base station that performs the concentrated control. The base station that performs the concentrated control decides a frequency and a power to be allocated to each of base stations in a group and each of terminals belonging to each base station. In this method, since it is possible to optimize the frequency and the power to be allocated to each base station and each terminal, it is possible to optimize the system throughput.

### CITATION LIST

### Non Patent Literature

NPTL 1: IEEE 802.16m 2011, Section 16.2 Medium Access Control

### SUMMARY OF INVENTION

### Technical Problem

As described above in the background art, in the cellular communication system using the OFDMA, interference in the cell edge or the sector edge is reduced by applying the FFR or the ICIC. However, in the FFR, the partition size allocated to the cell edge, that is, the size of frequency bandwidth is fixed, and it is impossible to adaptively change the size, for example, according to a load of a base station. In addition, in the ICIC, it is possible to adaptively change the size of the frequency bandwidth allocated to the cell edge, but in the wireless communication system in which the permutation operation is performed, the base stations need to be the same in the resource unit rearranging method by the permutation, and have to give up an effect that interference is reduced between the base stations by the permutation.

In addition, the ICIC can realize the higher system throughput than the FFR, but in the ICIC, the base stations need to exchange information with each other, and thus various kinds of information such as the SINR for all terminals connected to the base stations are transmitted from more than several tens of base stations of the ICIC control target to the base station that performs the concentrated control. For this reason, the amount of data necessary to transmit the information increases, and a traffic load increases. In addition, the base station that performs the concentrated control performs a process of allocating radio resources to each of all base stations of the control target and each of all terminals belonging to the base stations using the transmitted information of the respective terminals. All processes are concentrated to the base station that performs the concentrated control, and thus a processing load of the base station that performs the concentrated control increases.

In light of the foregoing, it is an object of the invention is to be able to adaptively change an allocation of radio resources, for example, according to a load state of a base station and improve frequency utilization efficiency of a base station by reducing influence of interference in an edge area between base stations in which the quality of a signal may deteriorate due to interference of signals transmitted from multiple base stations and a central area of a base station.

It is another object of the present invention to reduce a data amount of information exchanged between base stations and distribute a load in a base station that perform general control in a technique of performing control such that information is exchanged among multiple neighbor base stations, and an allocation of radio resources of each base station is adaptively changed and reducing deterioration in a signal quality that is caused by interference of signals transmitted from multiple neighbor base stations.

### Solution to Problem

In order to solve the above-described problem, in the invention, a cellular wireless communication system in which service areas are configured by arranging multiple base station devices that transmit or receive a radio signal to or from a terminal such that cells formed by the base station devices are adjacent to each other, the system includes multiple base station devices that determine whether a terminal performing communication with a base station device within the service area is located in a cell center or a cell edge, and performs scheduling so that communication with a terminal located in the cell center and communication with the terminal located in the cell edge are performed in different time zones.

In addition, the base station device performs communication such that multiple base station devices in the wireless communication system performs communication with the terminal located in the cell center in the same time zone, communication with the terminal located in the cell edge is performed in a time zone different from communication with the terminal located in the cell center, and time zones do not overlap in the cell edge between neighbor base station devices.

In addition, in a cell formed by the base station devices, when three base station units and is configured with three sectors, a time zone in which communication with the terminal located in the cell center includes a time zone in which all the three base station units perform communication with terminals, a time zone in which two of the three base station units perform communication with terminals, and a time zone in which one of the three base station units performs communication with terminals.

In addition, the cell center is further divided into a sector center, a left sector edge, and a right sector edge based on a position when viewed in a direction from a base station unit to a cell edge, which of the sector center, the left sector edge, and the right sector edge the terminal located in the cell center is located in is determined, and the time zone in which all the three base station units perform communication is allocated to communication with the terminal located in the sector center, the time zone in which two of the three base station units perform communication is allocated to communication with a terminal located in either of the left and right sectors edges according to a combination of the sector center and the two base station unit, and the time zone in which one of the three base station units perform communication is allocated to communication of a cell edge terminal which is one of the three base station units.

In order to solve the above-described problem, in the invention, multiple neighbor base stations is classified into one control base station and multiple control target base stations, a base station include a resource calculator that calculates an index value representing the number of bits transmittable by a unit radio resource for each terminal using communication quality information acquired from terminals that are performing communication with the base stations, multiple control target base stations transmits as many index values as the number of terminals to the control base station, the control base station allocates radio resources to multiple neighbor base stations and the terminals based on the index values of the terminals received from multiple control target base stations, the index values of the terminals of the control base station, and the number of terminals that are performing communication with the base stations which is decided based on the number of index values, and notifies the control target base stations of an allocation result.

In addition, the resource calculator of each base station calculates the index value based on the received quality information of each terminal using a common algorithm.

### Advantageous Effects of Invention

According to the present invention, it is possible to adaptively change an allocation of radio resources, for example, according to a load state of a base station and improve frequency utilization efficiency of a base station by reducing influence of interference in an edge area between base stations in which the quality of a signal may deteriorate due to interference of signals transmitted from multiple base stations and a central area of a base station.

In addition, it is possible to reduce a data amount of information exchanged between base stations and distribute a load in a base station that perform general control in a technique of performing control such that information is exchanged among multiple neighbor base stations, and an allocation of radio resources of each base station is adaptively changed and reducing deterioration in a signal quality that is caused by interference of signals transmitted from multiple neighbor base stations.

### BRIEF DESCRIPTION OF DRAWINGS

FIG. 1 is a diagram for describing a cellular wireless communication system according to an embodiment.

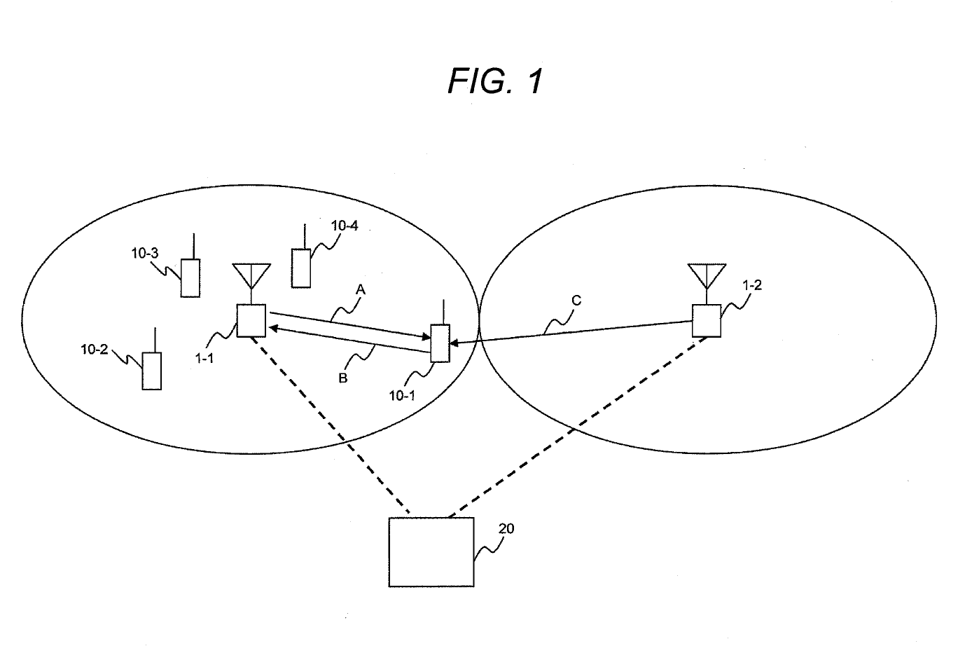

FIG. 2 is a diagram for describing a frequency using method of a base station when an FFR is applied.

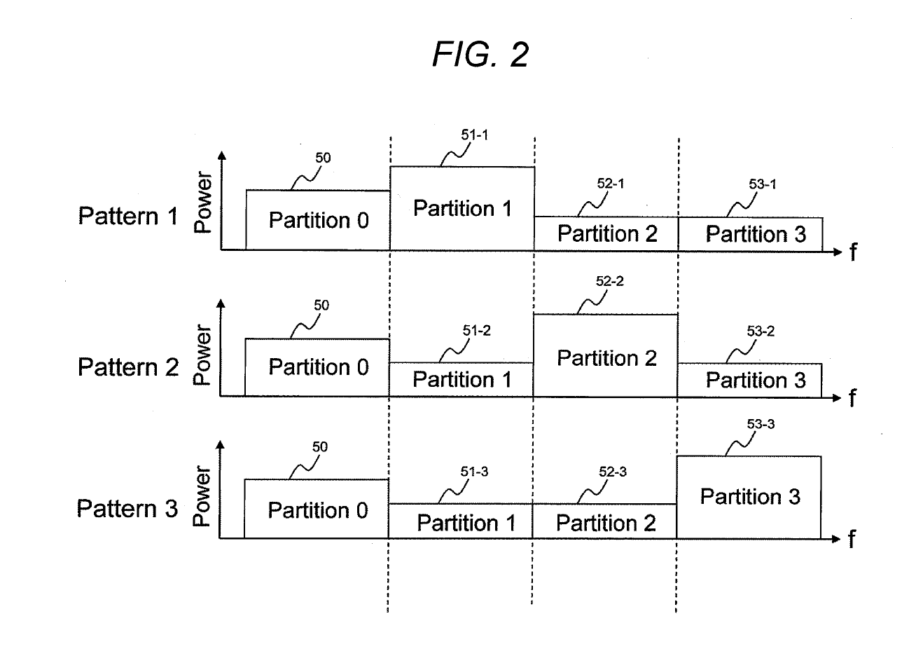

FIG. 3 is a diagram illustrating three neighbor base stations.

FIG. 4 is a diagram illustrating a concept of ICIC.

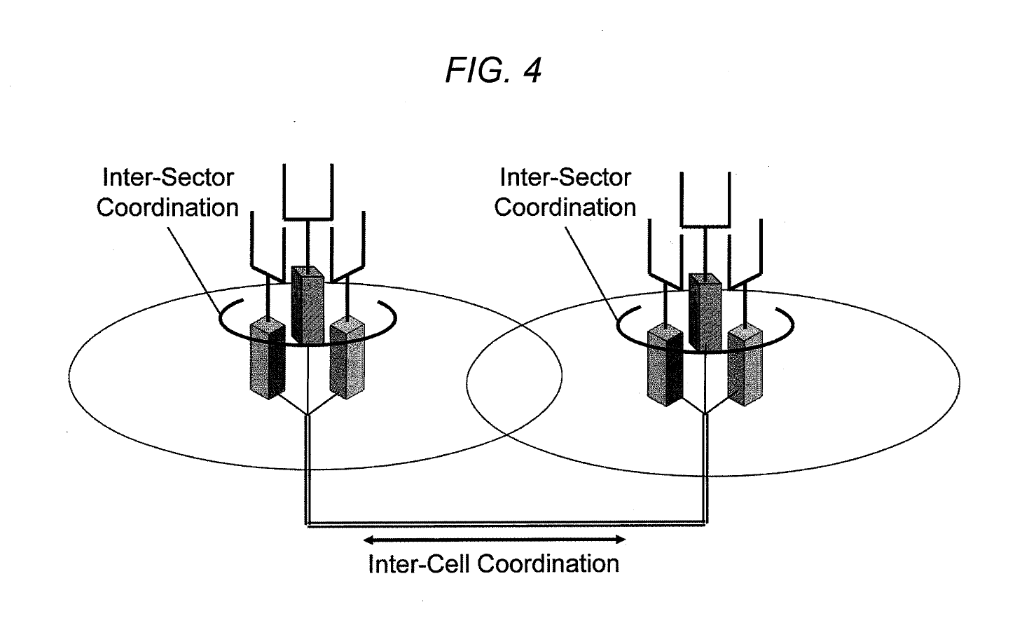

FIG. 5 is a diagram for describing a frequency using method of a base station when ICIC is applied.

FIG. 6 is a diagram for describing a cell sector configuration of multiple neighbor base stations.

FIG. 7 is a diagram for describing a radio resource allocating method on a time axis according to an embodiment of the present invention.

FIG. 8 is a diagram for describing a detailed sector configuration of a cell center area according to an embodiment of the present invention.

FIG. 9 is a diagram for describing a radio resource allocating method on a time axis according to an embodiment of the present invention.

FIG. 10 is a flowchart for describing a terminal position specifying process according to an embodiment of the present invention.

FIG. 11 is a diagram for describing a relation between the position and a terminal and whether communication is possible according to a type of time zone according to an embodiment of the present invention.

FIG. 12 is a sequence diagram illustrating communication between base stations according to an embodiment of the present invention.

FIG. 13 is a block diagram of a base station according to an embodiment of the present invention.

FIG. 14 is a block diagram of a baseband transmission signal processing unit according to an embodiment of the present invention.

FIG. 15 is a diagram for describing a radio resource allocating method of a base station according to an embodiment of the present invention.

FIG. 16 is a sequence diagram illustrating the flow of a process of deciding radio resources to be allocated to each base station according to an embodiment of the present invention.

FIG. 17 is a diagram illustrating a relation between a CINR and efficiency according to an embodiment of the present invention.

FIG. 18 is a flowchart for describing a process of deciding the number of radio resources used by each base station according to an embodiment of the present invention.

FIG. 19 is a flowchart for describing a process of deciding radio resources to be allocated to a terminal according to an embodiment of the present invention.

FIG. 20 is a sequence diagram illustrating the flow of a process of deciding radio resources to be allocated to each base station according to an embodiment of the present invention.

FIG. 21 is a flowchart for describing a process of deciding a terminal using radio resources for a cell center and a cell edge according to an embodiment of the present invention.

FIG. 22 is a block diagram of a base station according to an embodiment of the present invention.

### DESCRIPTION OF EMBODIMENTS

Hereinafter, preferred modes of the present invention will be described in detail using embodiments with reference to the appended drawings. The substantially same parts are denoted by the same reference numerals, and a description thereof will not be repeated. In addition, the description will proceed using systems according to LTE-Advanced and IEEE 802.16m as a wireless communication system, but the wireless communication system is not limited to these examples.

### First Embodiment

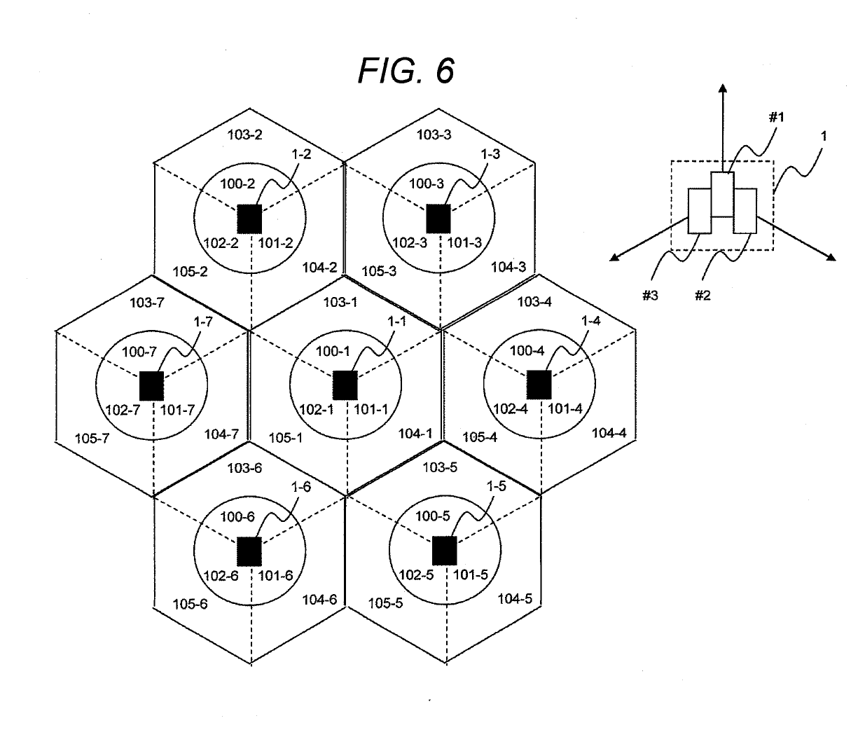

FIG. 6 is a diagram for describing a cell sector configuration of multiple neighbor base stations.

Referring to FIG. 6, each of seven base stations 1-1, 1-2, 1-3, 1-4, 1-5, 1-6, and 1-7 includes three sectors, and a cell is configured with three sectors. It can be regarded that each base station includes three base stations #1, #2, and #3, and the base stations #1, #2, and #3 configure three sectors. In other words, the base station #1 having a sector configured with areas 100-1 and 103-1, the base station #2 having a sector configured with areas 101-1 and 104-1, and the base station #3 having a sector configured with areas 102-1 and 105-1 are present in the base station 1-1. The areas 100-1, 101-1, and 102-1 serve as the cell center, and the areas 103-1, 104-1, and 105-1 serve as the cell edge. For the other base stations 1-2, 1-3, and the like, similarly, the base station #1 having a sector configured with areas 100-n and 103-n, the base station #2 having a sector configured with areas 101-n and 104-n, and the base station #3 having a sector configured with areas 102-n and 105-n are present, and the areas 100-n, 101-n, and 102-n serve as the cell center, and the area 103-n, 104-n, 105-n serve as the cell edge. Hereinafter, when an area is described without distinguishing the base stations 1-1 to 1-7, “-n” will be omitted.

In the cell centers 100, 101, and 102, the base stations #1 to #3 perform control such that transmission power has a level not to influence other cells, and thus interference on other cells is reduced. As a result, since interference applied from other cells is reduced, it is possible to perform communication using the same time and frequency resources as the base stations #1 to #3 of other cells. Meanwhile, in the cell edge 103, 104, and 105, influence of interference from the base stations #1 to #3 of other cells is large, and thus it is necessary to reduce interference. In the related art, interference is reduced by dividing radio resources into multiple partitions on the frequency axis, dividing frequencies to be allocated to the cell center and the cell edge, and controlling transmission power such that frequencies are orthogonal to each other between neighbor base stations.

In the present embodiments, focusing on the time axis, interference is reduced by controlling an allocation of radio resources on the time axis. The following embodiments will be described under the assumption that all base stations use the same frequency band, and the base stations are time-synchronized with each other.

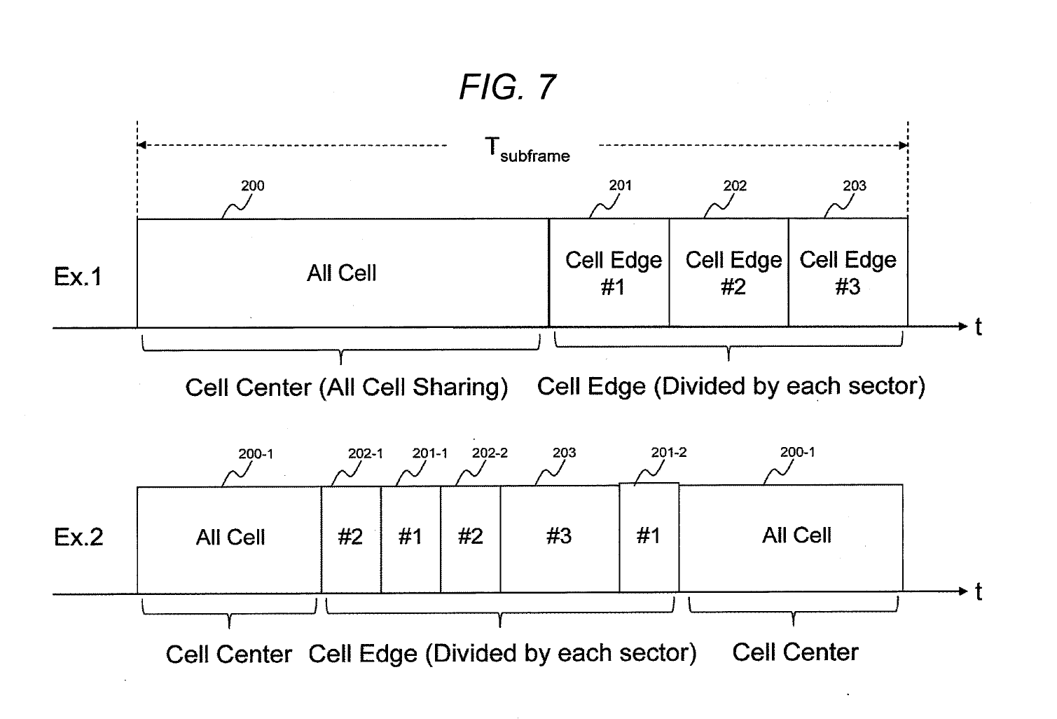

A method of controlling an allocation of radio resources on the time axis will be described with reference to FIGS. 6 and 7. In the present embodiments, a time length of a sub frame configured with several consecutive OFDM symbols is used as a unit of time.

FIG. 7 is a diagram illustrating a radio resource allocating method on the time axis according to an embodiment of the present invention.

In the present embodiments, radio resources are allocated in units of multiple sub frames. In FIG. 7, a horizontal axis represents a time, and a time length of multiple sub frames is represented by T_{subframe}. In the present embodiments, T_{subframe} is divided into a time zone 200 in which radio resources are shared by all cells and time zones 201, 202, and 203 in which communication is performed with a terminal located in the cell edge. A time zone dividing method is defined as a time schedule.

In an example 1 of FIG. 7, the base stations #1 to #3 performs communication with terminals located in the areas 100, 101, and 102 serving as the cell center by controlling transmission power such that the transmission power has a level not to influence the base stations of other cells, and thus, due to the above-described reason, all cells or multiple neighbor cells within the wireless communication system can share a time and perform communication. The time zone 201 is assumed to be a period of time in which the base station #1 performs communication with a terminal located in the area 103 serving as the cell edge. Similarly, the time zone 202 is assumed to be a period of time in which the base station #2 performs communication with a terminal located in the area 104 serving as the cell edge, and the time zone 203 is assumed to be a period of time in which the base station #3 performs communication with a terminal located in the area 105 serving as the cell edge.

In the areas 103, 104, and 105 of the cell edge, the area 103 uses the time zone 201, the area 104 uses the time zone 202, the area 105 uses the time zone 203, and thus in the cell edge between neighbor base stations, signals are not transmitted in the same time zone. In the present disclosure, what time zones in which a signal is transmitted are different between neighbor cells or sectors is regarded to be orthogonal as well. As described above, a time schedule is set for each cell edge so that base stations near the cell edge do not perform communication at the same time, and thus influence of interference in the cell edge between neighbor base stations is significantly reduced. In addition, each base station reduces interference by setting a time schedule on the time axis without dividing a frequency band on the frequency axis. Thus, the base stations need not have the same permutation method, and each base station can freely use a frequency band in a time zone in which each base station can perform communication.

As a time schedule setting method, time zones may be allocated in order to such as the time zone shared by all cells, the time zone for the cell edge #1, the time zone for the cell edge #2, and the time zone for the cell edge #3 as in the example 1 of FIG. 7, and a time zone allocation order may be changed as in an example 2. A time schedule may be decided by exchanging information such as the number of connected terminals between base stations belonging to different cells, but when information is exchanged between cells, it is necessary to transmit and receive a huge amount of information, and thus in the present embodiments, a time schedule is assumed to be set fixedly to all base stations on a system.

The above-described embodiment has been described in connection with a time schedule setting method of dividing a period of time into a time zone shared by all cells and a time zone for the cell edge when three sectors are configured with three base stations, but even when three sectors are configured with one base station or when one cell is configured with one base station, a time schedule can be similarly set based on the above-described embodiment.

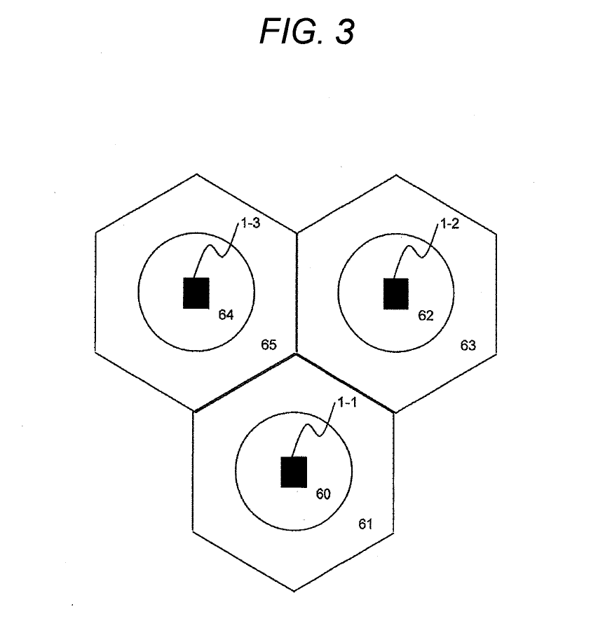

Next, an example in which one cell is configured with one base station will be described with reference to FIGS. 3 and 7.

The time zone 200 is assumed to be a period of time in which the base stations 1-1, 1-2, and 1-3 perform communication with terminals located in the cell centers 60, 62, and 64, the time zone 201 is assumed to be a period of time in which the base station 1-1 performs communication with a terminal located in the cell edge 61, the time zone 202 is assumed to be a period of time in which the base station 1-2 performs communication with a terminal located in the cell edge 63, and the time zone 203 is assumed to be a period of time in which the base station 1-3 performs communication with a terminal located in the cell edge 65. In the cell edge of the areas 61, 63, and 65, the time zone 201 is used in the area 61, the time zone 202 is used in the area 63, and the time zone 203 is used in the area 65, and thus in the cell edge between neighbor base stations, the base stations do not transmit a signal in the same time zone, and they are orthogonal to each other on the time axis. As described above, even when one cell is configured with one base station, it is possible to set a time schedule of dividing a period of time into a time zone shared by all cells or multiple neighbor cells with the wireless communication system and a time zone for the cell edge.

### Second Embodiment

Next, a second embodiment will be described.

The first embodiment has been described in connection with an example in which communications in the cell centers 100, 101, and 102 are simultaneously performed in the time zone shared by all cells. The second embodiment will be described in connection with an example of setting a time schedule by dividing an area and a time in further detail than in the first embodiment, considering that interference is likely to occur in a sector edge area in which 100, 101, and 102 come into contact with each other.

The time zone 200 in which communication is performed with terminals located in the cell centers 100, 101, and 102 is low in influence of interference from neighbor cells, and thus it is possible to independently set and operate a time schedule within a cell without needing to consider a relation with other cells. In other words, it is possible to freely set a time schedule among the three base stations #1 to #3 configuring a cell. In the present embodiments, the cell centers 100, 101, and 102 are not simply three sectors but define a sector configuration divided into smaller areas which are not defined in the past. The time schedule is set based on the detailed sector configuration. The detailed sector configuration and the time schedule setting method will be described below.

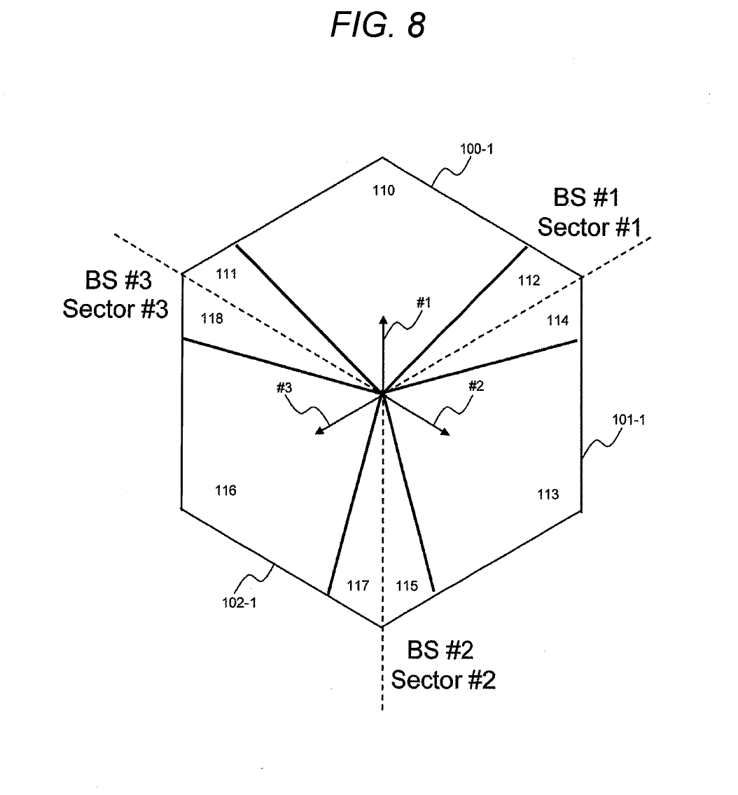

FIG. 8 is a diagram for describing a detailed sector configuration of a cell center area according to an embodiment of the present invention.

FIG. 8 is a diagram illustrating a sector configuration in which the areas 100-1, 101-1, and 102-1 of the cell center of the base station 1-1 of FIG. 6 are extracted and the areas 100-1, 101-1, and 102-1 are minutely divided.

Referring to FIG. 8, a center area 100-1 of a sector #1 of the base station #1 is further divided into areas 110, 111, and 112. Similarly, a center area 101-1 of a sector #2 of the base station #2 is divided into areas 113, 114, and 115, and a center area 102-1 of a sector #3 of the base station #3 is divided into areas 116, 117, and 118. Here, when an area of a sector edge at the left side when viewed in an arrival direction of a radio wave from a base station is referred to as a left sector edge, and a sector edge area at the right side when viewed in an arrival direction of a radio wave from a base station is referred to as a right sector edge, the areas 110, 113, and 116 serve as the sector center, the areas 111, 114, and 117 serve as the left sector edge, and the areas 112, 116, and 118 serve as the right sector edge. When three sectors are configured with three base stations #1 to #3, the base station is unlikely to be influenced by interference from the other two base stations in the sector centers 110, 113, and 116. Meanwhile, in the sector edges 111, 112, 114, 125, 117, and 118, the base stations #1 to #3 interfere with each other between sectors. For this reason, it is necessary to reduce influence of interference in the sector edge.

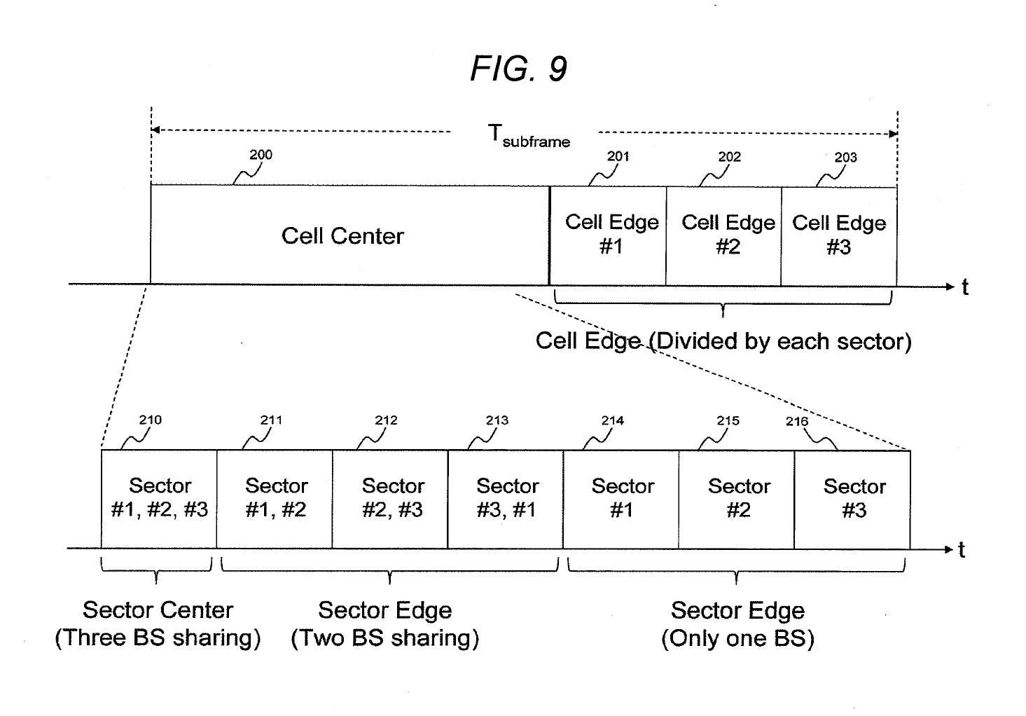

A time schedule setting method for a terminal located in the cell center will be described with reference to FIGS. 8 and 9. According to the present embodiments, in the time allocation illustrated in FIG. 7 in the first embodiment, the time schedule is set minutely for the time zone 200 or 200-1 in which communication is performed in a terminal located in the cell center in view of inter-sector interference.

FIG. 9 is a diagram illustrating a method of allocating radio resources on the time axis according to the second embodiment.

As illustrated in FIG. 9, according to the second embodiment, the time zone 200 is divided into a time zone 210 shared by the three base stations #1, #2, and #3 configuring the three sectors, time zones 211, 212, and 213 shared by two of the three base stations, and time zones 214, 215, and 216 shared by one base station. The time zone dividing method is defined as a time schedule. Here, each of the base stations #1 to #3 need to specify whether a terminal is in the cell edge or the cell center and whether the terminal in the cell center is located in the sector center area or the sector edge area before performing communication with the terminal based on the time schedule.

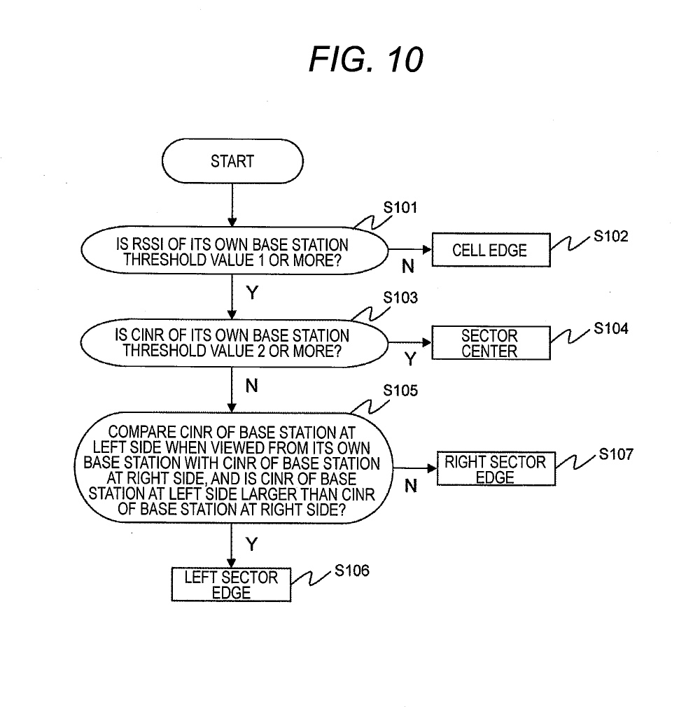

FIG. 10 is a flowchart for describing a process of specifying an area to which a terminal belongs.

In the flow illustrated in FIG. 10, a base station specifies an area with respect to a terminal using a carrier to interference and noise power ratio (CINR) that is a ratio of interference power and noise power to carrier power of a currently connected base station and two other base stations within its own cell and a received signal strength indication (RSSI). The parameters are obtained such that the terminal scans at regular intervals, and the terminal reports the result to the base station. The base station decides an area to which the terminal belongs based on the report result of the CINR and the RSSI from the terminal.

Referring to FIG. 10, the base station compares the report value of the RSSI reported from the terminal with a predetermined first threshold value (a threshold value 1) (S101). When the report value of the RSSI is smaller than the threshold value 1, the terminal is determined to be located in the cell edge (S102). When the report value of the RSSI is larger than the threshold value 1, the report value of the CINR received from the terminal is compared with a predetermined second threshold value (a threshold value 2) (S103). When the report value of the CINR is larger than the threshold value 2, the terminal is determined to be located in the sector center (S104). When the report value of the CINR is smaller than the threshold value 2, the terminal is determined to be located in the sector edge.

In addition, it is determined whether the terminal is located in the left sector edge or the right sector edge. The base station compares the report value of the CINR of the signal received from the base station at the left side when viewed from the base station with the report value of the CINR of the signal received from the base station at the right side when viewed from the base station (S105). As a result of the comparison, when the CINR of the base station at the left side is determined to be larger, the terminal is determined to be located in the left sector edge (S106). However, when the CINR of the base station at the right side is determined to be larger, the terminal is determined to be located in the right sector edge (S107). As a concrete example, when viewed from the base station #1, the base station at the left side is the base station #3, the base station at the right side is the base station #2.

Through the above operation, the base station specifies an area to which the terminal belongs, and decides a time zone in which communication can be performed for each terminal through a scheduler.

Referring back to FIGS. 8 and 9, the time schedule setting method in the time zone 200 will be continuously described. In the time zone 210, the base stations #1, #2, and #3 perform communication with terminals located in the areas 110, 113, and 116 serving as the sector center, and thus the three base stations perform communication in the same time zone. The time zone 214 is assumed to be a period of time in which the base station #1 performs communication with a terminal located in the area 110 serving as the sector center and terminals located in the areas 111 and 112 serving as the sector edge. At this time, in the present embodiments, since the other base stations #2 and #3 do not perform communication, influence of interference in the areas 111 and 112 serving as the sector edge of the base station #1 is reduced. Similarly, the time zone 215 is assumed to be a period of time in which the base station #2 performs communication with a terminal located in the area 113 serving as the sector center and terminals located in the areas 114 and 115 serving as the sector edge, and the time zone 216 is assumed to be a period of time in which the base station #3 performs communication with a terminal located in the area 116 serving as the sector center and terminals located in the areas 117 and 118 serving as the sector edge.

In the present embodiments, the time zones 211, 212, and 213 in which two base stations perform communication are set. Using the three-sector configuration by the three base stations illustrated in FIG. 8, even when two base stations perform communication at the same time, it is possible to reduce influence of interference. The method will be described below.

A method of configuring an area in which communication can be performed in the time zones 211, 212, and 213 in which two base stations perform communication will be described. When the base station #1 and the base station #2 perform communication at the same time, influence of interference is large in the area 112 and the area 114 serving the sector edge. However, in the area 111 and the area 115 serving as the sector edge, influence of interference is small since the base station #3 does not perform communication. Therefore, when the base station #1 and the base station #2 perform communication at the same time, the base station #1 and the base station #2 can respectively perform communication with terminals located in the area 111 and the area 115. Similarly, when the base station #2 and the base station #3 perform communication at the same time, the base station #2 and the base station #3 can respectively perform communication with terminals located in the area 114 and the area 118, and when the base station #3 and the base station #1 perform communication at the same time, the base station #3 and the base station #1 can respectively perform communication with terminals located in the area 117 and the area 112.

In light of the above, the time zone 211 is a time zone in which communication can be performed with a terminal located in the left sector edge 111 of the base station #1 and a terminal located in the right sector edge 115 of the base station #2, and communication can be performed with terminals located in the sector centers 110 and 113 as well. The time zone 212 is a time zone in which communication can be performed with a terminal located in the left sector edge 114 of the base station #2 and a terminal located in the right sector edge 118 of the base station #3, and communication can be performed with terminals located in the sector centers 113 and 116 as well, and the time zone 213 is a time zone in which communication can be performed with a terminal located in the left sector edge 117 of the base station #3 and a terminal located in the right sector edge 112 of the base station #1, and communication can be performed with terminals located in the sector centers 110 and 116 as well.

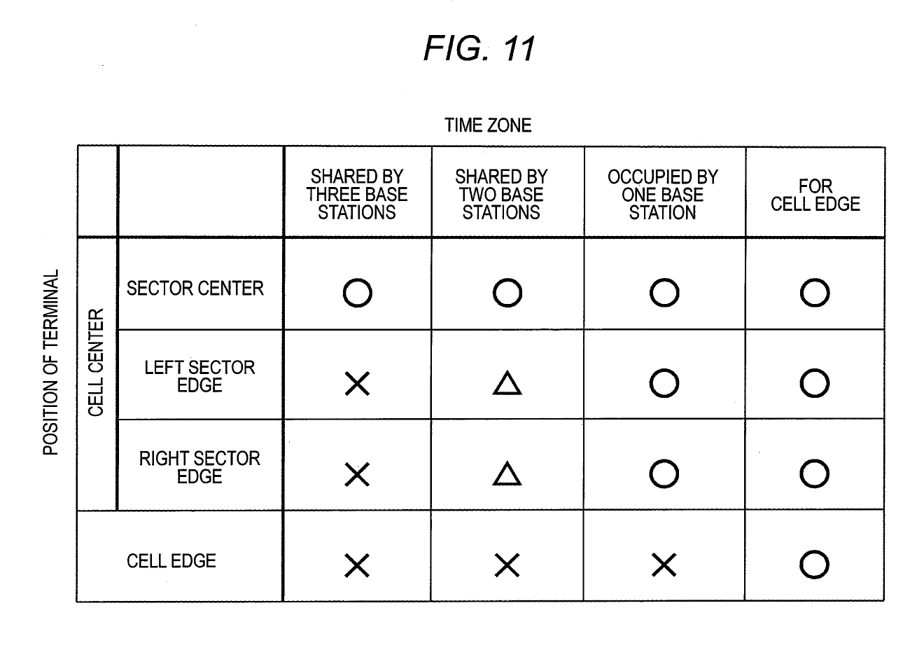

Here, the position of a terminal at which communication can be performed for each time zone such as a period of time in which the three base stations perform communication will be described with reference to FIG. 11. In FIG. 11, ◯ represents that communication can be performed, Δ represents that communication can be performed conditionally, and X represents that it is difficult to perform communication. In the time zone in which three base stations perform communication, the base station performs communication with the terminal located in the sector center. In the time zone in which two base stations perform communication, the base station performs communication with the terminal located in the sector center and the terminal located in either of the left sector edge or the right sector edge according to a base station forming a pair. In the time zone occupied by one base station, the base station performs communication with the terminal located in the sector center and the left and right sector edges. In the time zone for the cell edge, the base station mainly performs communication with the terminal located in the cell edge, but can perform communication with the terminals located in the sector center and the left and right sector edges as well.

By setting a time schedule in which a time zone is, divided into period of times in which communication is performed with the terminals located in the cell center and the cell edge, and a period of time for the cell center is further divided into a period of time in which three base stations perform communication with the terminal located in the sector center, two base stations perform communication with the terminals located in the left and right sector edges and the sector center, and a period of time in which one base station performs communication with the terminals located in the sector edge and the sector center, it is possible to reduce influence of interference in the cell edge and the sector edge. In the interference reducing method using the time schedule, it is possible to freely use the frequency band in the time zone in which each base station can perform communication. In addition, by setting the time zone in which two base stations perform communication, it is possible to increase a period of time in which communication is performed in the sector center while securing a period of time in which communication is performed in the sector edge, and thus the frequency utilization efficiency of the base station is improved.

In order for the base stations #1, #2, and #3 to perform communication according to the time schedule, the base station needs to detect an area in which the terminal is located, and information of the time schedule needs to be shared between the base stations. Next, a method in which the respective base stations specify an area to which a terminal belongs and share time schedule information will be described.

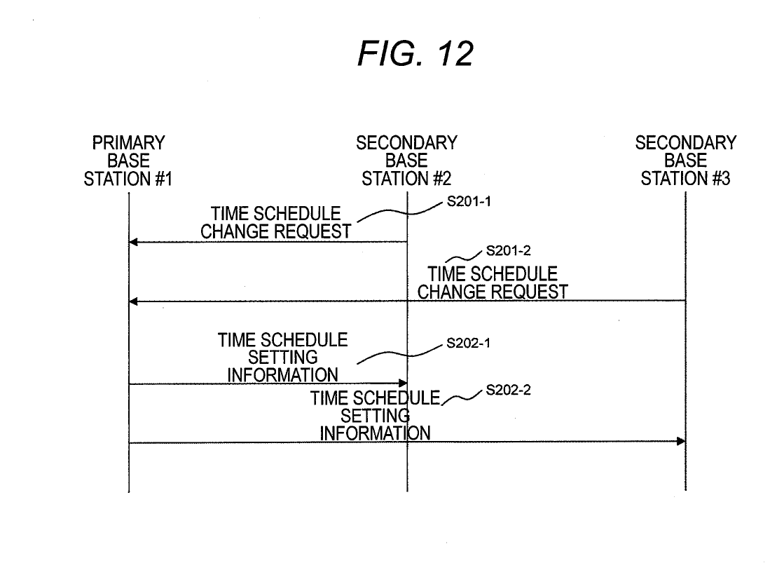

FIG. 12 is a sequence diagram of communication for sharing time schedule information between base stations. In FIG. 12, the three base stations are defined as a primary base station #1, a secondary base station #2, and a secondary base station #3. Here, the base station #1 configuring the sector #1 is associated with the primary base station #1, the base station #2 configuring the sector #2 is associated with the secondary base station #2, and the base station #3 configuring the sector #3 is associated with the secondary base station #3. In addition, a base station other than the base station #1 may be used as the primary base station #1. The secondary base station notifies the primary base station of a time schedule change request message at regular intervals (S201). For example, the message includes information such as the number of terminals of each area which is decided by the flowchart of FIG. 10. Upon receiving the time schedule setting change request message, the primary base station changes the time schedule setting. The primary base station may independently change the time schedule setting even when the time schedule setting change request message is not received from the secondary base station.

After changing the time schedule setting, the primary base station transmits time schedule setting information to each secondary base station (S202). As a method of notifying of the time schedule setting information, there are a method of notifying a period of time corresponding to each sub frame among “the time zone 210, the time zone 211, the time zone 212, the time zone 213, the time zone 214, the time zone 215, the time zone 216, the time zone 201, the time zone 202, and the time zone 203 of FIG. 9” or a method of preparing multiple time schedule patterns between base stations in advance and notifying of an index of a time schedule to be used from among the patterns.

Through the above operation, the respective base stations can share the time schedule setting information.

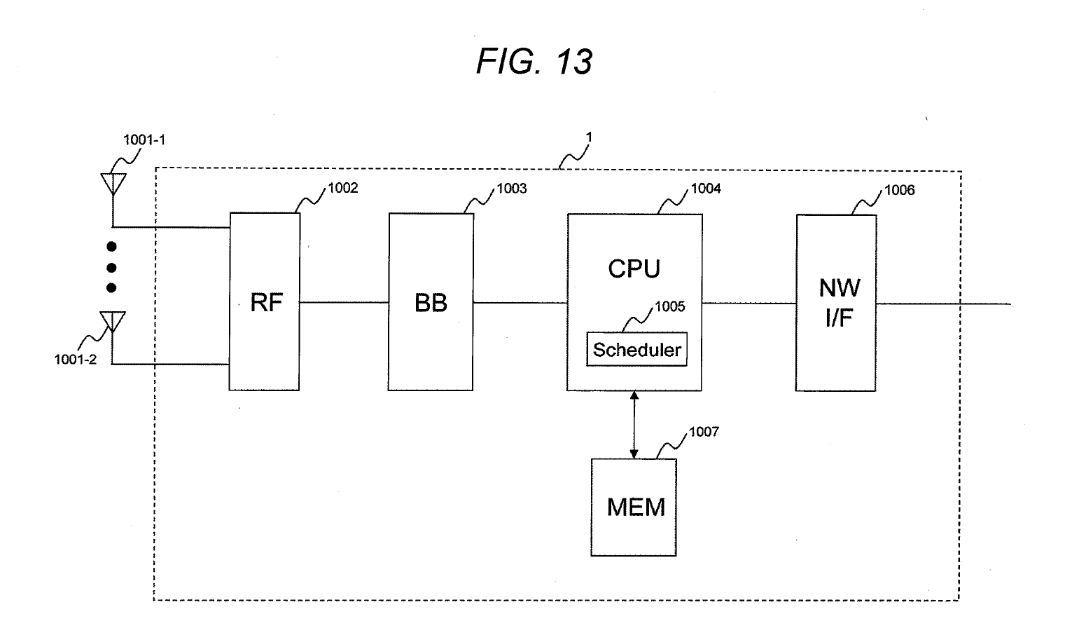

FIG. 13 illustrates an exemplary configuration of a base station.

Referring to FIG. 13, the base station includes an antenna 1001, a radio frequency (RF) unit 1002, a baseband signal processing unit 1003, a central processing unit (CPU) 1004, a network interface (NW I/F) unit 1006, and a memory 1007. The CPU unit 1004 includes a scheduler 1005.

The NW I/F unit 1006 includes an interface with a network, and performs transmission and reception of the time schedule setting information according to an embodiment between base stations. The CPU unit 1004 controls the overall base station. The scheduler 1005 is mounted in the CPU unit 1004, and decides a transmission timing, a transmission beam, a modulation and coding scheme, transmission power, and a frequency resource allocation. The memory 1007 accumulates the time schedule setting information according to an embodiment, control information necessary for transmission and reception, and downlink signals transmitted from the network. The baseband signal processing unit 1003 performs baseband signal processing. The RF unit 1002 performs a transform process between an analog transmission/reception signal and a baseband signal. A process of controlling the base station in the time zone according to the present embodiments is integrated into the scheduler 1005 and performed.

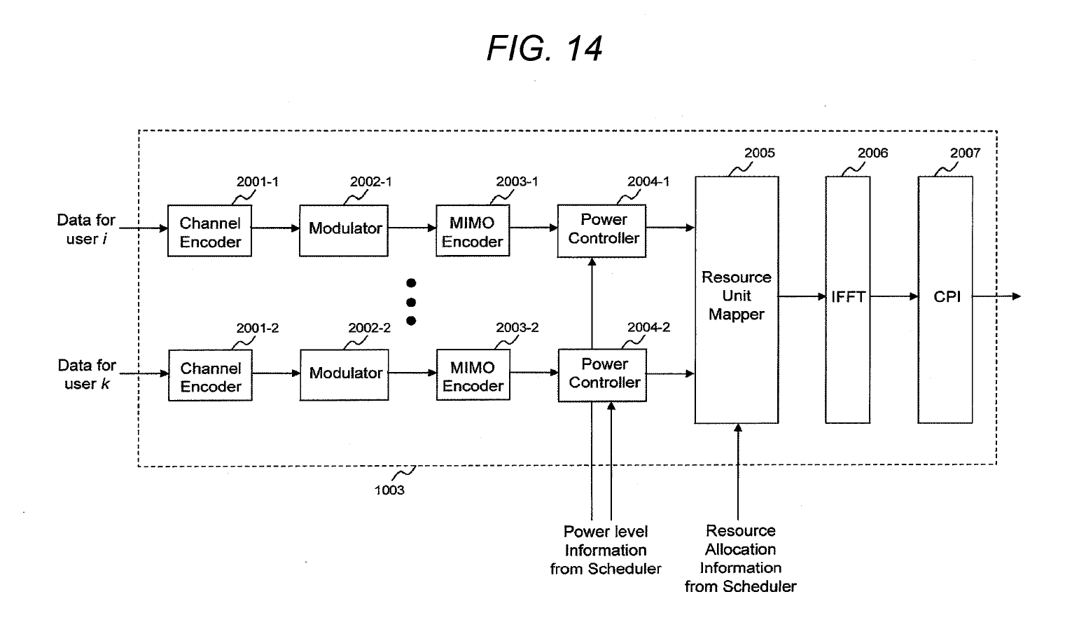

FIG. 14 illustrates an exemplary configuration of the baseband signal processing unit of the base station.

Referring to FIG. 14, a transmitting unit of the baseband signal processing unit 1003 includes a channel encoder 2001, a modulator 2002, a MIMO encoder 2003, a power controller 2004, a resource unit mapper 2005, an inverse FFT (IFFT) unit 2006, and a cyclic prefix insertor (CPI) unit 2007.

The channel encoder 2001 performs error correction coding on transmission data of multiple users from a user i to a user k. The modulator 2002 performs a modulation process. The MIMO encoder 2003 performs a transform process for MIMO. The power controller 2004 adjusts transmission power. The resource unit mapper 2005 performs mapping to resources allocated to each user according to a frequency resource allocation decided by the scheduler 1005. The IFFT unit 2006 performs a transform process of transforming a signal in the frequency domain into a signal in the time domain. The CPI unit 2007 adds a CP. Next, the description will proceed with transmission signal processing when a transmission signal is transmitted to the terminal located in the sector center in the time zone for the sector center defined by the time schedule according to an embodiment, that is, the time zone shared by three base stations.

Referring back to FIG. 13, first, the NW I/F unit 1006 receives a downlink signal transmitted from a network. The memory 1007 connected to the CPU unit 1004 once accumulates the received signal. The scheduler 1005 mounted in the CPU 1004 decides a transmission beam, a modulation and coding scheme, transmission power, and a frequency resource allocation for the received signal, and decides transmission of a signal based on the time schedule that is generated according to the present embodiments and accumulated in the memory 1007. The received signal is processed into a transmission signal according to the decision.

Referring to FIG. 14, the channel encoder 2001 performs error correction coding on transmission data of the user accumulated in the memory 1007 connected to the CPU unit 1004. Then, the modulator 2002 converts the data that has been subjected to the error correction coding into a modulation signal. The modulation signal is a signal having a constellation on an IQ signal plane as in QPSK, 16QAM, or 64QAM. Thereafter, the MIMO encoder 2003 performs MIMO signal processing on the modulation signal, and distributes the processed signal to respective antennas. The power controller 2004 adjusts power of the input signal. The signal having the power controlled by the power controller 2004 is input to the resource unit mapper 2005. The resource unit mapper 2005 maps signals of the respective users to resources allocated to the respective users according to the frequency resource allocation decided by the scheduler 1005. The mapping to the resources is performed for each antenna. The IFFT unit 2006 converts information of each antenna in the frequency domain into a signal in the time domain. The CPI unit 2007 adds a CP to the obtained signal in the time domain, and transmits a baseband transmission signal to the RF unit 1002 of FIG. 13. The RF unit 1002 converts the baseband signal into an RF signal, and transmits the transmission signal through the antenna 1001.

The point of the present embodiments lies in a mechanism of setting a time schedule in which the time zones are divided for the sector center, the sector edge, and the cell edge on the time axis instead of reducing interference by dividing the frequency band for the sector center, the sector edge, and the cell edge on the frequency axis. The operation of the scheduler that identifies terminals capable of performing communication in each time zone according to a time schedule and performing scheduling is within the scope of the present invention.

### Third Embodiment

Next, a third embodiment will be described.

FIG. 6 is referred to again.

In the cell centers 100, 101, and 102, the base stations #1 to #3 perform control such that transmission power has a level not to influence other cells, and thus interference on other cells is reduced, and interference applied from other cells is consequently reduced as well. Thus, in the cell centers 100, 101, and 102, it is possible to perform communication using the same time and frequency resources as in the base stations #1 to #3 of other cells. Meanwhile, in the cell edge 103, 104, and 105, influence of interference from the base stations #1 to #3 of other cells is large, and thus it is necessary to further reduce interference using a certain interference control technique. In the present embodiment, interference is reduced by exchanging information between neighbor base stations and deciding radio resources to be allocated to respective base stations to be orthogonal to that of a neighbor base station. In addition, in the present embodiment, an interference reduction technique that is smaller in the amount of information exchanged between base stations is small and a load on a base station than the related art is implemented.

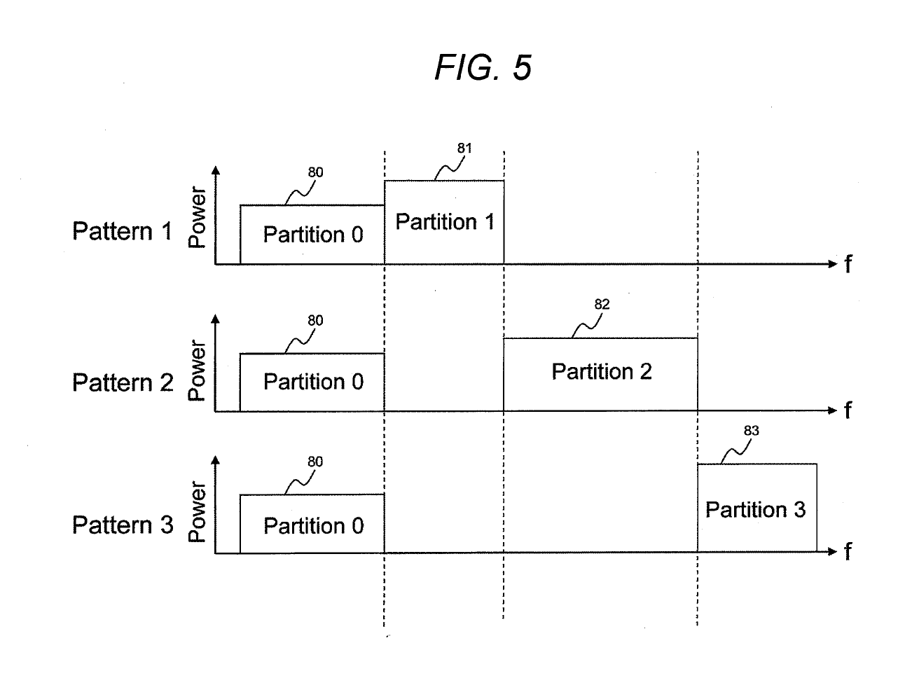

A method of reducing interference in the cell edge will be described with reference to FIGS. 5 and 6. The terminals located in the cell centers 100, 101, and 102 are allocated the partition 80 of each pattern, the terminal located in the cell edge 103 is allocated the partition 81 of the pattern 1 of FIG. 5, the terminal located in the cell edge 104 is allocated the partition 82 of the pattern 2, and the terminal located in the cell edge 105 is allocated the partition 83 of the pattern 3.

In the areas 103, 104, and 105 of the cell edge, the area 103 uses the partition 81, the area 104 uses the partition 82, and the area 105 uses the partition 83, and thus the same partition is not used in the cell edge between neighbor base stations, and it is possible to reduce influence of interference in the cell edge. In FIG. 5, a frequency is divided into multiple partitions, but a time direction may be divided into multiple partitions instead of a frequency. In the present embodiments, “allocating radio resources” means either or both of “allocating frequency” and “allocating a time”.

Commonly, the size of radio resources allocated to the partitions 80, 81, 82, and 83 may be decided by exchanging information such as the number of connected terminals between base stations belonging to different cells. However, since a huge amount of information has to be transmitted and received to exchange information between cells as described above, in the third embodiment, the size of the partitions 80 to 83 is assumed to have a fixed value in all base stations on a system. In the third embodiment, the information is not exchanged between cells, and the size of the partitions 80 to 83 has a fixed value in all base stations, but as will be described below in detail, for the partition 80, information is exchanged between base stations controlling a sector, and radio resources in which a partition has a variable size are allocated.

As described above, communications with the terminals located in the cell centers 100, 101, and 102 are simultaneously performed while sharing the partition 80, but interference is likely to occur in the sector edge area in which the areas 100, 101, and 102 come into contact with each other. Since the partition 80 is low in influence of interference from a neighbor cell, it is possible to independently allocate radio resources within a cell without needing to consider a relation with other cells. In other words, it is possible to freely allocate radio resources among the three base stations #1 to #3 configuring a cell. The detailed sector configuration will be described below.

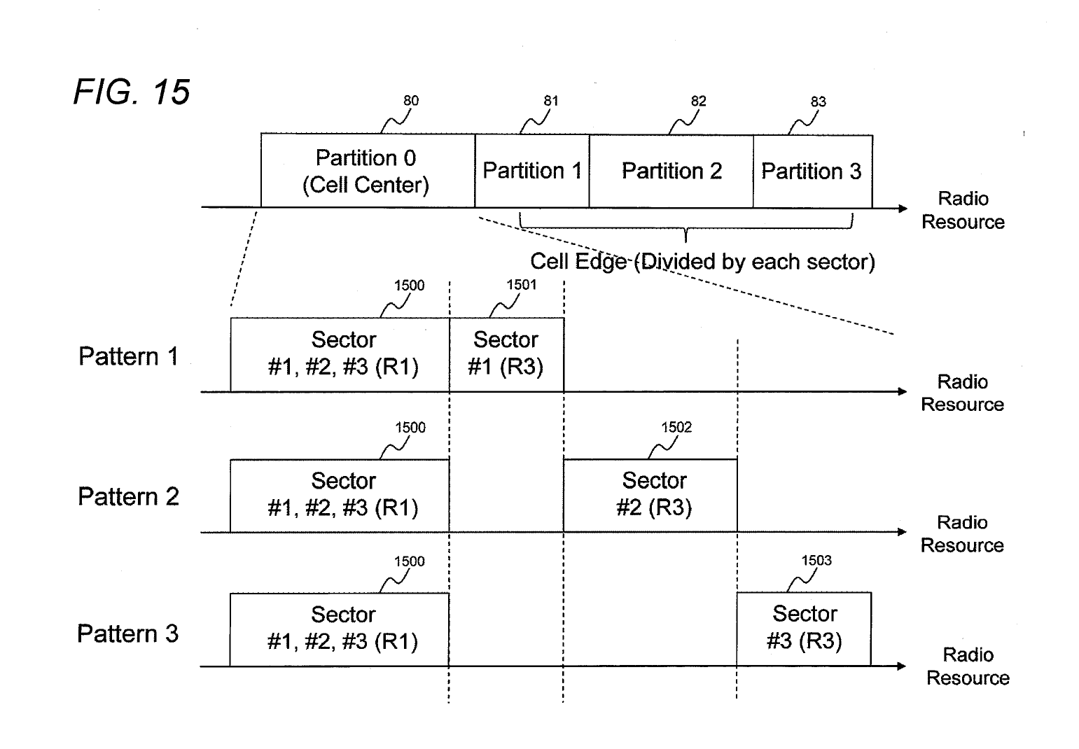

A method of reducing interference in the sector edge will be described with reference to FIGS. 8 and 15. Here, for the partition 80 in which communication is performed with the terminal located in the cell center in the radio resource allocation illustrated in FIG. 5, radio resources are minutely allocated in view of inter-sector interference. FIG. 15 is a diagram illustrating a method of further subdividing the partition 80 of the cell center area and allocating radio resource.

As illustrated in FIG. 15, in the third embodiment, the partition 80 is divided into a radio resource 1500 shared by the three base stations #1, #2, and #3 and radio resources 1501, 1502, and 1503 occupied by one base station. Here, radio resources shared by the three base stations are referred to as R1 (Reuse 1 (frequency repetition 1)) resources, and radio resources occupied by one base station are referred to as R3 (Reuse 3 (frequency repetition 3)) resources. Here, terminals located in the sector centers 110, 113, and 116 are allocated the radio resource 1500 of the patterns 1 to 3, terminals located in the cell edges 111 and 112 are allocated the radio resource 1501 of the pattern 1, the terminals located in the cell edges 114 and 115 are allocated the radio resource 1502 of the pattern 2, and the terminals located in the cell edges 117 and 118 are allocated the radio resource 1503 of the pattern 3.

In the areas 111, 112, 114, 115, 117, and 118 of the sector edge, the areas 111 and 112 use the radio resource 1501, the areas 114 and 115 use the radio resource 1502, and the areas 117 and 118 use the radio resource 1503, and thus the same radio resource is not used in the sector edge between the three base stations configuring a cell, and it is possible to reduce influence of interference in the sector edge. The R1 resources are radio resources for the sector center, and the R3 resources are radio resources for the sector edge.

Here, the size of the radio resources 1500, 1501, 1502, and 1503 can be decided by exchanging information such as the number of connected terminals between the three base stations belonging to the same cell since it is unnecessary to consider a relation with other cells. In the related art, various information of all terminals of all base stations serving as the control target is gathered to one base station that performs concentrated control, and the base station that performs concentrated control calculates a parameter used to allocate radio resources to all terminals of all base stations serving as the control target based on the gathered various information, and decides radio resources to be allocated to all terminals of all base stations serving as the control target based on the calculation result.

The present embodiment provides a method in which information gathered to the base station that performs concentrated control is restricted, each base station serving as the control target calculates an index used for an allocation of radio resources by the base station that performs concentrated control, and the base station that performs concentrated control performs only an allocation of available radio resource for each base station and notifies other base stations of allocation information, and thus data amount necessary for information exchange is reduced, and a processing load in the base station that performs concentrated control is distributed.

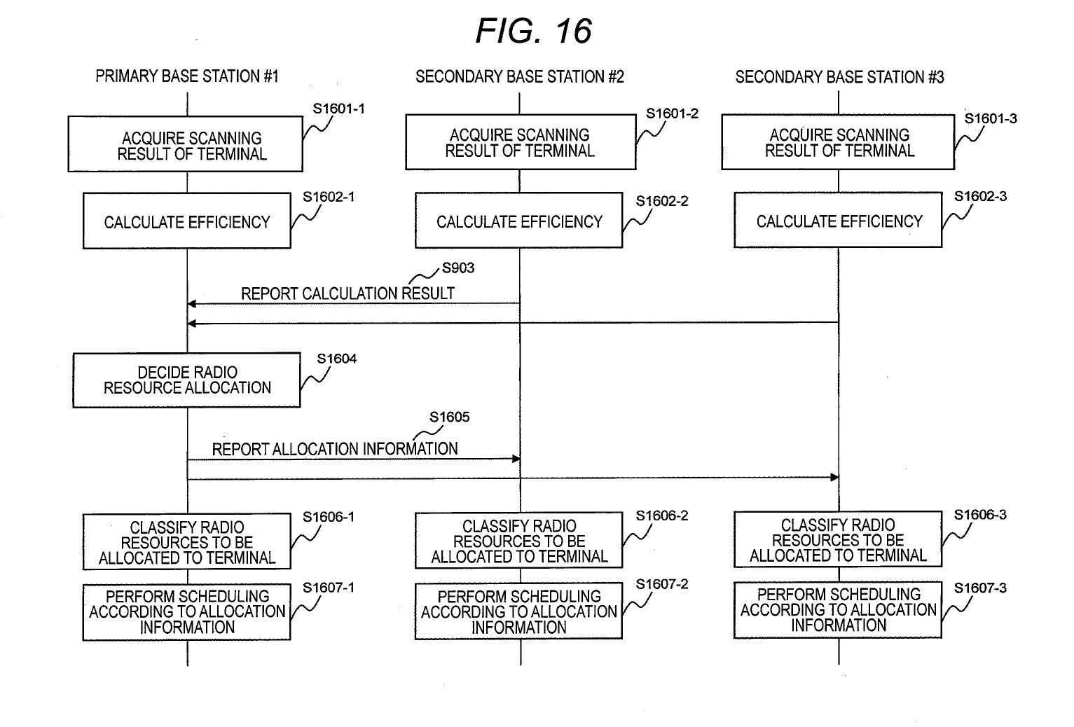

FIG. 16 is a sequence diagram illustrating the flow of a process of exchanging information between base stations and deciding radio resources to be allocated to the base stations #1 to #3.

In FIG. 16, the three base stations are defined as the primary base station #1, the secondary base station #2, and the secondary base station #3, respectively. Here, the base station #1 configuring the sector #1 is associated with the primary base station #1, the base station #2 configuring the sector #2 is associated with the secondary base station #2, and the base station #3 configuring the sector #3 is associated with the secondary base station #3. In addition, a base station other than the base station #1 may be used as the primary base station #1. A base station used as the primary base station may be set by an operator or may be automatically selected according to a predetermined set selection rule. The base stations #1 to #3 cause the terminals within the sector of each base station to scan a CINR that is a ratio of interference power and noise power to carrier power of a currently connected base station and two other base stations within its own cell and an RSSI at regular intervals, and acquire the result from the terminals (S1601).

Then, the base stations #1 to #3 calculate efficiency based on the scan results of the terminals (S1602). Here, the efficiency represents the number of transmittable bits per resource element obtained by dividing a frequency using a fast Fourier transform (FFT) in the OFDMA scheme. As an example of a concrete numerical value of the efficiency, the efficiency is 8 when QPSK (2 bits can be transmitted by one symbol) is used as a modulation scheme, and MIMO in which the number of transceiving antennas is 4. A method of calculating the efficiency according to the present embodiments will be described later using mathematical formulas. The efficiency is an index mainly used when scheduling is performed in a base station, and used only in one base station. In the past, when interference control is performed between base stations by transceiving information between base stations, the base station that performs concentrated control performs a calculation of the efficiency and an allocation of radio resources under the concentrated control based on various information of all terminals received from all base stations serving as the control target. In the present embodiment, focusing on the efficiency, the efficiency calculating method is commonalized among multiple base stations performing interference control, the calculation of the efficiency is performed by each base station, and information of the efficiency is exchanged between base stations instead of restrictively using the calculation result only in one base station.

Referring back to FIG. 16, after the efficiency is calculated, the secondary base stations #2 and #3 transmit the value of the efficiency to the primary base station #1 (S1603). The primary base station decides radio resources to be allocated to each base station based on information of the efficiency acquired from the secondary base station and information of the efficiency acquired from the primary base station (S1604). Then, the primary base station transmits radio resource allocation information to the secondary base station (S1605). The base stations #1 to #3 specifies one of radio resources for the sector center and radio resources for the sector edge which is to be allocated for communication as radio resources to be allocated to each terminal before performing communication with the terminal according to the radio resource allocation information (S1606). Finally, terminals are scheduled according to the radio resource allocation information (S1607).

Through the above operation, it is possible to decide radio resources to be allocated to the base stations #1 to #3 and share the allocation information between base stations.

Next, a detailed operation of the process of S1602, S1604, and S1606 will be described.

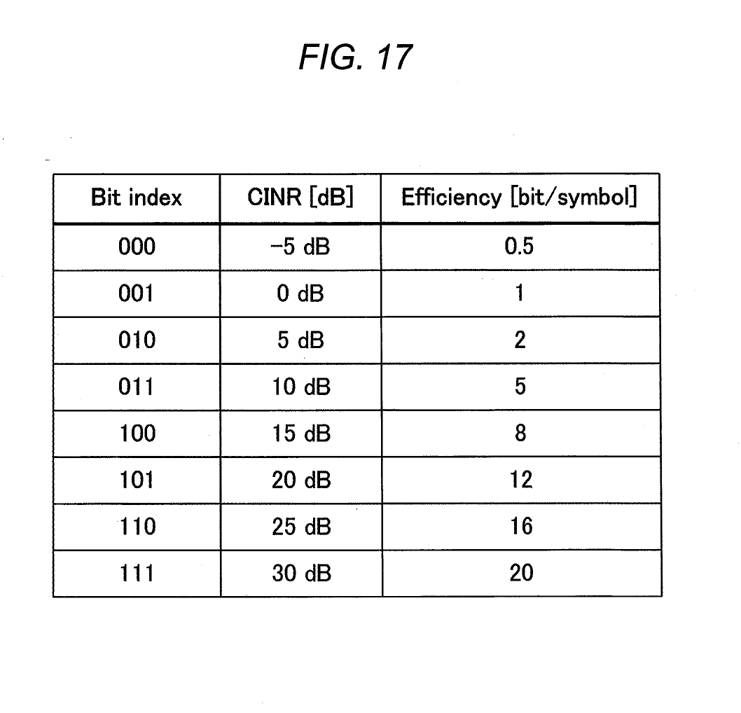

The process of S902 of calculating the efficiency based on the scanning result acquired from the terminal will be described with reference to FIG. 17 using a mathematical formula.

FIG. 17 is a diagram illustrating a relation between the CINR and the efficiency.

The base stations #1 to #3 acquire the CINR and the RSSI of its own base station and the other two base stations from the terminals. Here, the CINR of its own base station is defined as CINR_{S}, the RSSI of its own base station is defined as RSSI_{S}, the RSSI of a base station at the left side when viewed in the arrival direction of the radio wave from its own base station is defined as RSSI_{L}, and the RSSI of a base station at the right side when viewed in the arrival direction of the radio wave from its own base station is defined as RSSI_{R}. Using these values, the base stations #1 to #3 derive CINR_{R1} representing the CINR when interference is applied as the three base stations use the same radio resources (R1 resources) and CINR_{R3} representing the CINR when there is no inter-sector interference as one base station occupies radio resources (R3 resources). CINR_{R1} becomes CINR_{S} since terminal scanning is performed under the assumption that all base stations use the same radio resources. CINR_{R3} is obtained using the following formula.

When the sum of interference power from base stations other than three base stations configuring three sectors is γ, and noise power is n, Formula 1 holds:

[symbol]

### [Mathematical Formula 1]

Since the CINR when there is no inter-sector interference is obtained as CINR_{R3}, Formula 2 is obtained.

### [Mathematical Formula 2]

Here, Formula 3 is obtained from Formula 1.

### [Mathematical Formula 3]

Formula 4 is obtained from Formulas 2 and 3.

### [Mathematical Formula 4]

For the calculated CINR_{R1} and CINR_{R3}, efficiency_R1 representing the efficiency when interference is applied as the three base stations use the same radio resources and efficiency_R3 representing the efficiency when there is no inter-sector interference as one base station occupies radio resources are obtained with reference to FIG. 17. The base stations #1 to #3 compare the values of CINR_{R1} and CINR_{R3} with the value of the CINR of FIG. 17, and obtain the efficiency corresponding to the closest CINR as the efficiency_R1 and the efficiency_R3. The calculation of the efficiency is performed by the number of terminals connected to the base station. The efficiency may be obtained using linear interpolation based on a value before and after the CINR of FIG. 17 which is close to the values of CINR_{R1} and CINR_{R3}. A relation between the CINR and the efficiency of FIG. 17 is an example, and the relation between the CINR and the efficiency is not limited to this example as long as the efficiency is output when the CINR is input.

After the efficiency is derived, the secondary base station transmits the information of the efficiency to the primary base station. At this time, only the value of the efficiency is notified of instead of a form in which a terminal ID is associated with the efficiency. As a method of notifying of the information of the efficiency, there are a method of indexing the efficiency and notifying of a corresponding number and a method of converting the value of the efficiency into a bit and notifying of the bit as illustrated in FIG. 17.

In the third embodiment, the efficiency when three base stations interfere with one another and the efficiency when there is no inter-sector interference are obtained, but it is possible to obtain the efficiency when two of three base stations perform communication and the two base stations interfere with each other as well. When the CINR when there is no interference from a base station at the left side when viewed in the arrival direction of the radio wave from its own base station and there is interference from a base station at the right side is CINR_{L}, and the CINR when there is no interference from the base station at the right side and there is interference from the base station at the left side is CINR_{R}, CINR_{L} and CINR_{R} can be calculated as follows using the same method as the deriving method of Formula 4.

[symbol]

### [Mathematical Formula 5]

### [Mathematical Formula 6]

By comparing the calculated CINR_{L} and CINR_{R} with the table of FIG. 17, it is possible to obtain the efficiency when the two base stations perform communication and there is interference between the two base stations as well.

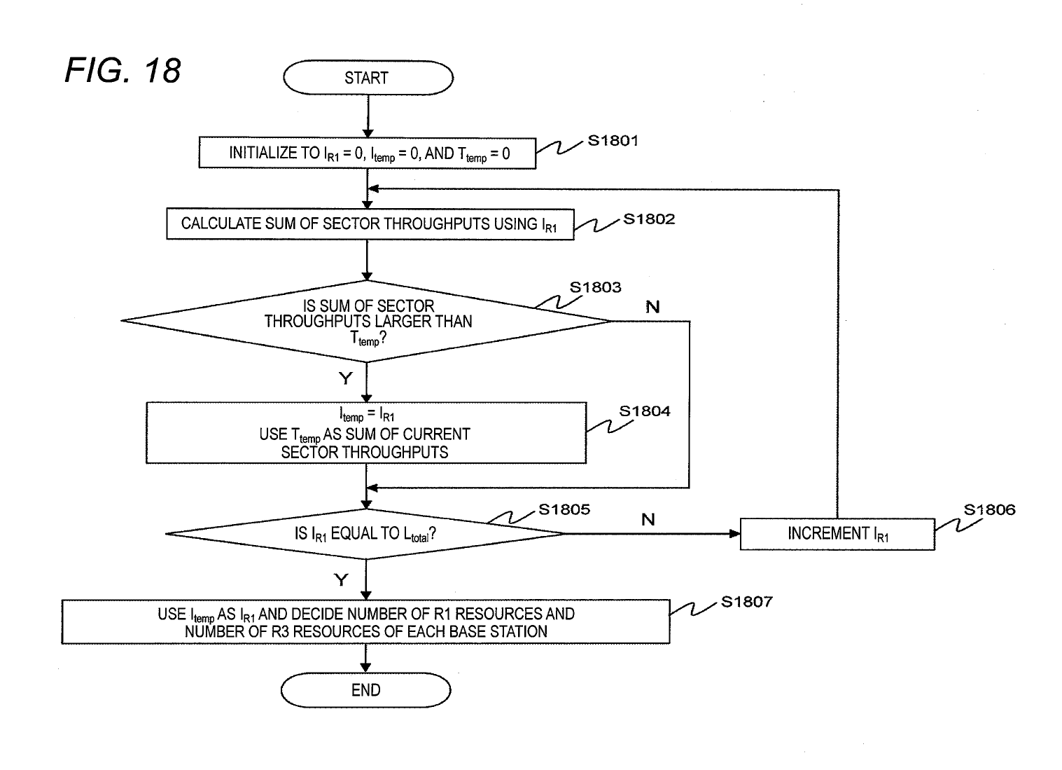

The process of S1604 of deciding radio resources to be allocated to the base stations #1 to #3 based on information of the efficiency will be described with reference to FIGS. 15 and 18 using mathematical formulas.

FIG. 18 is a flowchart for describing a process of deciding the number of radio resources used by the base stations #1 to #3.

The primary base station #1 acquires the efficiency_R1 and the efficiency_R3 from its own base station and the secondary base stations #2 and #3. The number of terminals of each base station may be decided based on the number of efficiencies acquired for each base station. Here, radio resources in the partition 80 of FIG. 15 are equally divided into Lₜₒₜₐₗ. For example, a value of Lₜₒₜₐₗ is set by the operator in advance. As a value of Lₜₒₜₐₗ an arbitrary value such as Lₜₒₜₐₗ=10 is set by the operator.

In addition, the R1 resources used by three base stations configuring three sectors are defined as l_{R1}, the R3 resources used by a base station i (i is a value from 1 to 3) are defined as l_{R3}_{_{—}}ᵢ, the number of terminals connected to the base station i is defined as Nᵢ, the number of terminals allocated to the R1 resources among the terminals connected to the base station i is defined as the number of terminals allocated to the R1 resources is defined as n_{R3}_{_{—}}ᵢ, the efficiency_R1 of a terminal k of the base station i is defined as (r_{R1}_{_{—}}ᵢ,k), the efficiency_R3 is defined as (r_{R3}_{_{—}}ᵢ,k), the throughput in the R1 resources of the terminal k of the base station i is defined as (S_{R1}_{_{—}}ᵢ,k), the throughput in the R3 resources is defined as (S_{R3}_{_{—}}ᵢ,k), and the sector throughput of the base station i is defined as Tᵢ.

Here, the base stations are assumed to be the same in the number of terminals connected to the R1 resources. In addition, since a ratio of the R3 resources of the base stations #1 to #3 is the same as a ratio of the number of terminals allocated to the R3 resources of the base stations #1 to #3, n_{R1}_{_{—}}ᵢ=n_{R1}. From these parameters, the following Formulas 7 to 11 are obtained. Here, indices k of the terminal used in these Formulas are rearranged in the descending order of the efficiency_R1.

### [Mathematical Formula 7]

### [Mathematical Formula 8]

### [Mathematical Formula 9]

### [Mathematical Formula 10]

### [Mathematical Formula 11]

In the above Formulas, the number n_{R1} of terminals connected to the R1 resources and the number l_{R1} of the R1 resources are a variable. Here, since the base stations are the same in the number of terminals connected to the R1 resources and the ratio of the R3 resources of the base stations #1 to #3 is the same as the ratio of the number of terminals allocated to the R3 resources of the base stations #1 to #3, the following relational expression 12 holds for the two variables.

### [Mathematical Formula 12]

It can be understood from Formula 12 that it is desirable to find a value of l_{R1} that is largest in the sum (T₁+T₂+T₃) of the sector throughputs of the base stations #1 to #3 when a value of l_{R1} is changed from 0 within the range of Lₜₒₜₐₗ.

Next, a process of deciding the number of the R1 resources and the number of the R3 resources allocated to the base stations #1 to #3 which is performed by the primary base station #1 will be described with reference to the flowchart illustrated in FIG. 18 using Formulas 7 to 12.

First, initialization is performed such that l_{R1}=0, lₜₑₘₚ=0, and Tₜₑₘₚ=0 (S1801). Here, lₜₑₘₚ represents a temporary optimal value of l_{R1}, and Tₜₑₘₚ represents a temporary maximum value of the sum of the sector throughputs. Then, the primary base station calculates Formulas 7 to 12 using l_{R1}, and, obtains the sum (T₁+T₂+T₃) of the sector throughput (S1802). After calculating the sum of the sector throughputs, the primary base station compares the sum with the value of Tₜₑₘₚ (S1803). When the calculated sum of the sector throughputs is larger than the value of Tₜₑₘₚ, l_{R1}=lₜₑₘₚ, and Tₜₑₘₚ is used as the current sum of the sector throughputs (S1804). On the other hand, the calculated sum of the sector throughputs is smaller than the value of Tₜₑₘₚ the process of S204 is not performed. Thereafter, it is determined whether the current value of l_{R1} has reached Lₜₒₜₐₗ (S1805). When the value of l_{R1} is smaller than Lₜₒₜₐₗ, the value of l_{R1} is incremented, the process returns to S1802, and the process of S1802 to S1805 is repeated (S1806). The process is repeated until the value of l_{R1} is equal to Lₜₒₜₐₗ, and when the value of l_{R1} is equal to Lₜₒₜₐₗ the primary base station determines that the current value of lₜₑₘₚ is l_{R1} that maximizes the sum of the sector throughputs, and uses the number of the R1 resources as the value of l_{R1}. Then, the number l_{R3}_{_{—}}ᵢ of the R3 resources used by each base station i is decided using Formulas 7, 8, and 12 (S1807).

The radio resources to be allocated to the base stations #1 to #3 are decided based on the number of the R1 resources and the number of the R3 resources of the base stations #1 to #3 decided above. Here, since radio resources in the partition 80 of FIG. 15 are divided into Lₜₒₜₐₗ radio resources, 0-th to (l_{R1}−1)-th radio resources 200 are used as the R1 resources. Similarly, l_{R1}-th to (l_{R1}+l_{R3}_{_{—}}₁−1)-th radio resources 1501 are used as the R3 resources allocated to the base station #1, (l_{R1}+l_{R3}_{_{—}}₁)-th to (l_{R1}+l_{R3}_{_{—}}₁+l_{R3}_{_{—}}₂−1)-th radio resources 1502 are used as the R3 resources allocated to the base station #2, and (l_{R1}+l_{R3}_{_{—}}₁+l_{R3}_{_{—}}₂)-th to (l_{R1}+l_{R.} _{_{—}}₁+l_{R3}_{_{—}}₂+l_{R3}_{_{—}}₃−1 (Lₜₒₜₐₗ−1))-th radio resources 1503 are used as the R3 resources allocated to the base station #3. In this way, it is possible to allocate available radio resources to each base station. The radio resource allocation information is transmitted from the primary base station to multiple secondary base stations.

In the third embodiment, the order in which radio resources are allocated is set to the order of the R1 resources, the R3 resources of the base station #1, the R3 resources of the base station #2, and the R3 resources of the base station #3, but the order in which radio resources are allocated may be changed like the order of the R3 resources of the base station #2, the R1 resources, the R3 resources of the base station #3, and the R3 resources of the base station #1.

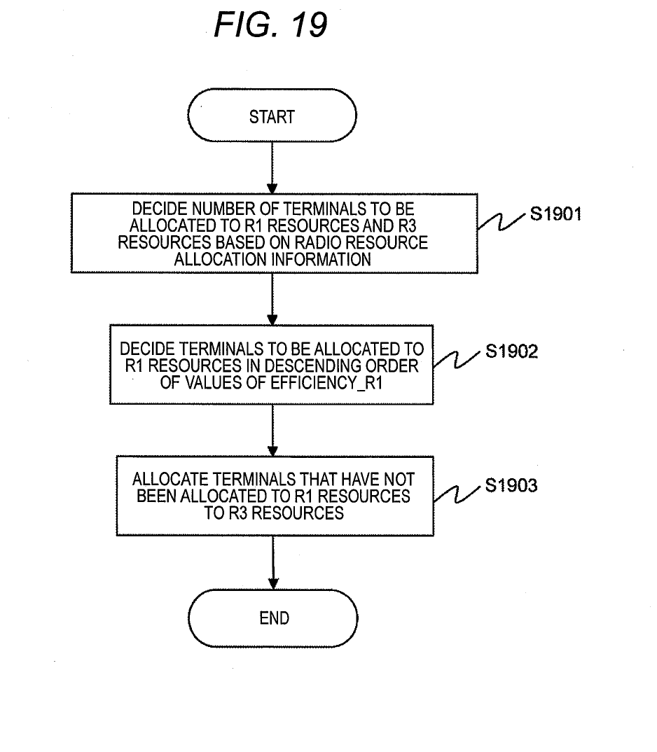

The process of S1606 of deciding radio resources to be allocated to the terminals belonging to the base stations #1 to #3 will be described with reference to FIG. 19.

FIG. 19 is a flowchart for describing a process of deciding radio resources to be allocated to a terminal.

In the flow illustrated in FIG. 19, the radio resources to be allocated to the terminal are decided using the efficiency_R1 obtained by calculating the CINR and the RSSI acquired from the scanning result of the terminal. The base stations #1 to #3 decide one of the R1 resources and the R3 resources to be allocated to the terminal according to these values.

In FIG. 19, the base stations #1 to #3 acquire the number l_{R1} of the R1 resources and the number l_{R3}_{_{—}}ᵢ (i is a base station number) of the R3 resources allocated to its own base station based on the radio resource allocation information, and decides the number n_{R1} of terminals to be allocated to the R1 resources and the number n_{R3}_{_{—}}ᵢ of terminals allocated to the R3 resources based on the values using Formulas 7 and 12 (S1901). As the terminals to be allocated to the R1 resources, n_{R1} terminals are selected in the descending order of the values of the efficiency_R1, and the selected terminals are allocated to the R1 resources (S1902). Then, n_{R3}_{_{—}}ᵢ terminals that have not been allocated to the R1 resources are allocated to the R3 resources (S1903). In deciding the radio resources to be allocated to the terminal, the efficiency calculated based on the scanning result of the terminal is used, but the efficiency calculated based on channel quality information (CQI) that is feedback information from the terminal may be used.

Through the above-described process, it is possible to decide the amount of the radio resources to be allocated to the three base stations #1 to #3 configuring three sectors and reduce influence of inter-sector interference. In addition, as information to be transmitted from the secondary base station that does not decide an radio resource allocation to the primary base station that decides an radio resource allocation, the efficiency and the bit obtained by indexing the efficiency other than the CINR and RSSI are used for transmission, and thus it is possible to reduce data amount necessary for transmission. For the processing load in the primary base station, the efficiency is calculated based on the CINR and the RSSI received from the secondary base station, and then the radio resource allocation is performed, but after the secondary base station is caused to calculate the efficiency, the efficiency is received, and the radio resource allocation is performed using the efficiency, and thus the load can be distributed.

### Fourth Embodiment

Next, a fourth embodiment will be described.

The third embodiment has been described in connection with the method of exchanging information of the efficiency between the three base stations configured with the three sectors and deciding the radio resources to be allocated to each base station. The fourth embodiment will be described in connection with a method of exchanging information of the efficiency between base stations belonging to different cells and deciding the size of the partition 80 to be allocated to the cell centers 100, 101, and 102, that is, a radio resource 80, a radio resource 81 to be allocated to the cell edge 103, a radio resource 82 to be allocated to the cell edge 104, and a radio resource 83 to be allocated to the cell edge 105 which have a fixed value in the third embodiment.

In the fourth embodiment, multiple cells are set as one group, information is exchanged between base stations within a group to decide the radio resources to be allocated to the cell center and the cell edge. Here, the description will proceed with an example in which 7 cells illustrated in FIG. 6 is set as one group.

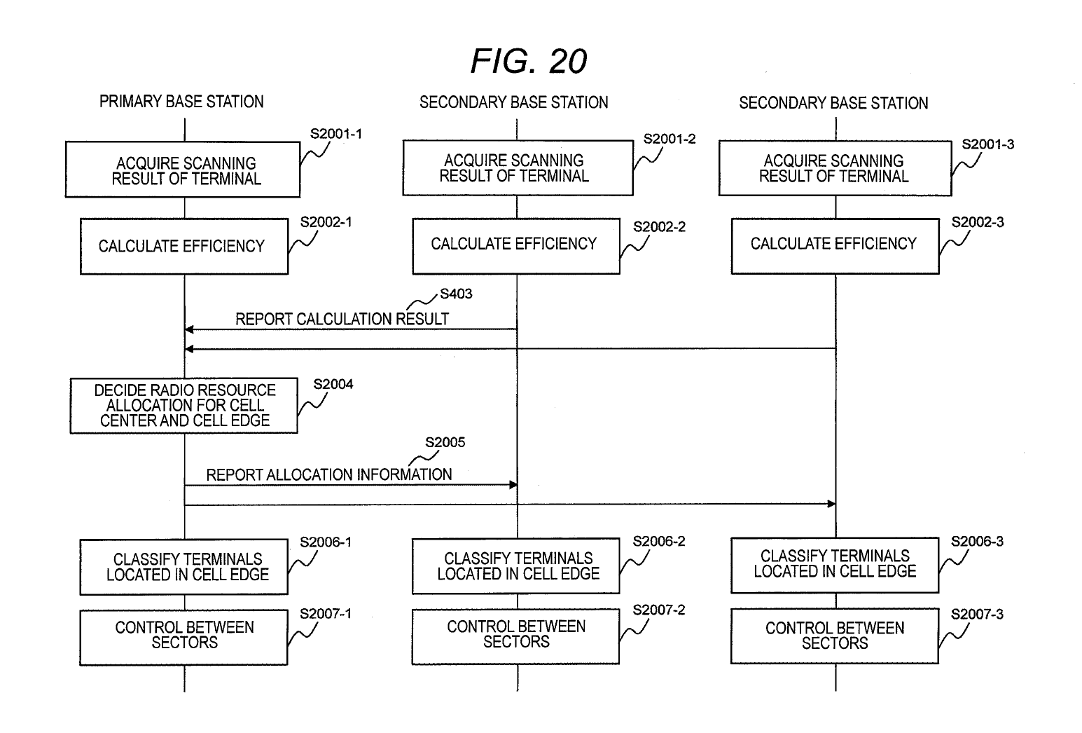

FIG. 20 is a sequence diagram illustrating the flow of a process of exchanging information between base stations belonging to different cells and deciding radio resources for the cell center and the cell edge to be allocated to the base stations 1-1 to 1-7.

In FIG. 20, similarly to the third embodiment, one primary base station is set. Here, the base station #1 within the base station 1-1 is set as the primary base station, but any other base station may be set as the primary base station.

First, the base stations 1-1 to 1-7 acquire the CINRs and the RSSIs of three base stations configuring three sectors in its own cell and three base stations configuring three sectors in a neighbor cell from the terminals (S2001). Here, the CINR of its own base station in its own cell is defined as CINR_{S}, the RSSI of its own base station is defined as RSSI_{S}, the RSSIs of the left and right sectors in its own cell when viewed in the arrival direction of the radio wave from its own base station are defined as RSSI_{L} and RSSI_{R}, and the RSSIs of the left and right sectors in a cell m (m is a value within a range of 1 to 6) adjacent to its own cell when viewed in the arrival direction of the radio wave from its own base station are defined as RSSI_{L}_{_{—}}ₘ and RSSI_{R}_{_{—}}ₘ (when its own base station includes the area 103, the left sector is a sector including the area 105, and the right sector is a sector including the area 104).

In the fourth embodiment, CINR_{R6} representing the CINR when there is no inter-cell interference is newly derived using radio resources (R6 resources) to be allocated to the cell edge. A method of calculating CINR_{R6} is obtained by Formula 13 when the method of obtaining Formula 4 is applied.

### [Mathematical Formula 13]

By comparing CINR_{R6} with the table illustrated in FIG. 17, the efficiency_R6 representing the efficiency when there is no inter-cell interference is obtained (S2002). The secondary base station transmits the efficiency_R6 and the efficiency_R3 to the primary base station (S2003). In deciding the radio resource allocation of the cell center and the cell edge, the process is performed under the assumption that there is no inter-sector interference in the cell center area, and thus it is unnecessary to transmit the efficiency_R1.

The primary base station decides the radio resources to be allocated to the cell center and the cell edge of each base station based on information of the efficiency acquired from the secondary base station and information of the efficiency acquired by its own base station (S2004). A concrete method is similar to that of the third embodiment, and when all radio resources are equally divided into Lₜₒₜₐₗ, preferably, l_{R3} that is largest in the sum of the throughputs of all sectors within one group is obtained while changing the value of the number l_{R3} of radio resources for the cell center within the range of 0 to Lₜₒₜₐₗ, the number of radio resources for the cell center and the cell edge is decided. Here, the R3 resources of the fourth embodiment corresponds to the R1 resources of the third embodiment, and the R6 resources of the fourth embodiment corresponds to the R3 resources of the third embodiment.

After the radio resources to be allocated to the cell center and the cell edge are decided, the primary base station transmits the radio resource allocation information of the cell center and the cell edge to the secondary base station (S2005). When the information is transmitted, the process between base stations belonging to different cells is completed, but thereafter, the radio resource allocation process is performed among the three base stations illustrated in FIG. 16 in each cell. Before performing the process, the base stations 1-1 to 1-7 decides a terminal that is to perform communication using the radio resources for the cell edge, and excludes the decided terminal from the target terminal of the radio the resource allocation process between the three base stations (S2006).

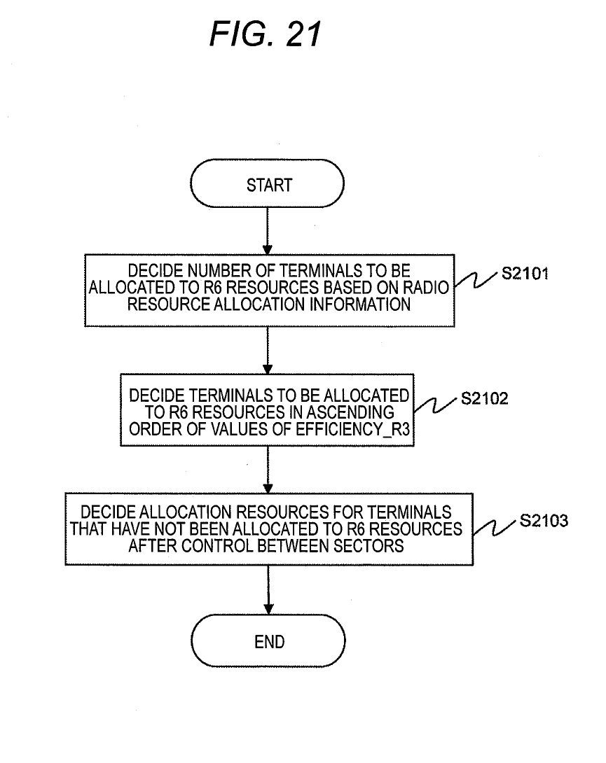

A method of deciding a terminal using radio resources for the cell edge will be described with reference to FIG. 21.

FIG. 21 is a flowchart for describing a process of deciding a terminal using radio resources for the cell edge. In FIG. 21, the efficiency_R3 obtained by calculating the CINR and the RSSI acquired from the scanning result of the terminal is used.

Referring to FIG. 21, the base stations 1-1 to 1-7 decides the number n_{R6} of terminals to be allocated to the R6 resources based on the radio resource allocation information (S2101). As the terminals to be allocated to the R6 resources, n_{R6} terminals are selected in the ascending order of the values of the efficiency_R3, and the selected terminals are allocated to the R6 resources (S2102). The terminals allocated to the R6 resources are determined to be located in the cell edge. Then, the terminals that have not allocated to the R6 resources are determined to be located in the cell center, and after the radio resource allocation is performed between sectors, the R1 resources or the R3 resources are decided as the resources allocated to the terminals (S2103). In deciding the radio resources to be allocated to the terminal, the efficiency calculated based on the scanning result of the terminal is used, but the efficiency calculated based on channel quality information (CQI) that is feedback information from the terminal may be used.

After the process of S2006 is completed, the radio resource allocation process is performed among the three base stations (S2007).

The fourth embodiment has been described in connection with the method of allocating the radio resource for the cell center and the cell edge when three sectors are configured with three base stations. However, even when three sectors are configured with one base station or even when one cell is configured with one base station, the same radio resource allocation can be performed based on the above-described embodiment. In addition, the fourth embodiment has been described in connection with the example in which one groups is configured with 7 cells, and the radio resource allocation is performed within a group. However, the method according to the present embodiments can be applied even when one group is configured with 7 or more cells, for example, 19 cells.

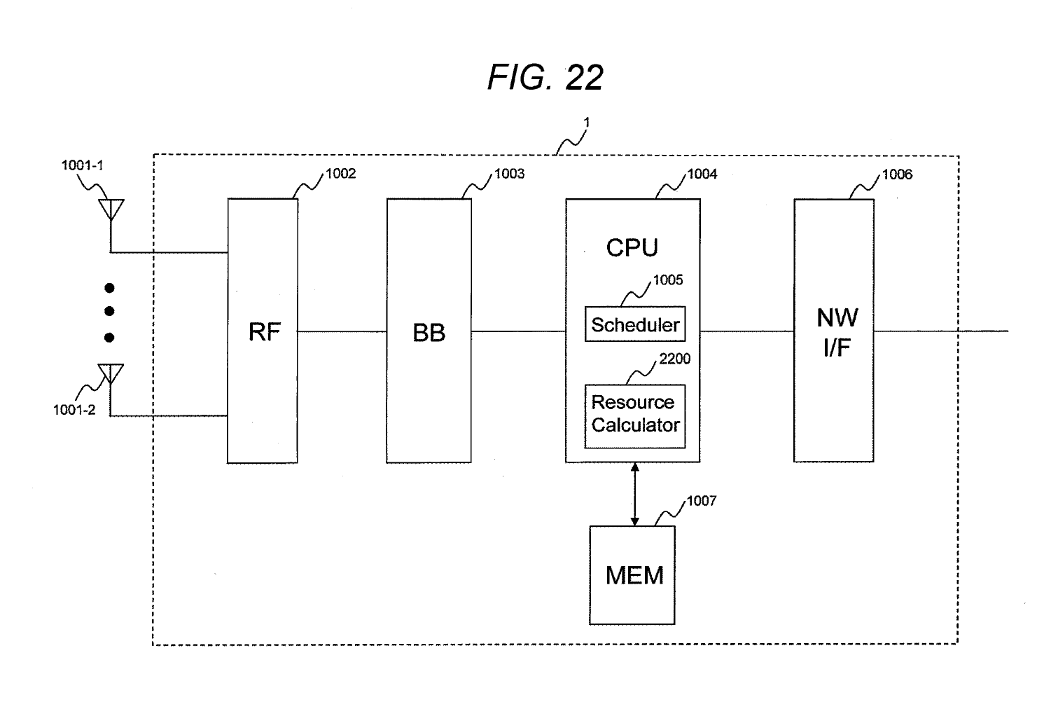

FIG. 22 illustrates an exemplary configuration of a base station.

Referring to FIG. 22, the base station includes an antenna 1001, an RF unit 1002, a baseband signal processing unit 1003, a CPU unit 1004, an NW I/F unit 1006, and a memory 1007. The CPU unit 1004 includes a scheduler 1005 and a resource calculator 2200 that performs processing related to a radio resource allocation according to an embodiment.

The NW I/F unit 1006 includes an interface with a network, and performs transmission and reception of the efficiency information and the radio resource allocation information according to an embodiment between base stations. The CPU unit 1004 controls the overall base station. The scheduler 1005 is mounted in the CPU unit 1004, and decides a transmission timing, a transmission beam, a modulation and coding scheme, transmission power, and a frequency resource allocation. The resource calculator 1006 is mounted in the CPU unit 1004, and performs a calculation of the efficiency, generation of a transmission message for notifying of the efficiency information, decision of radio resources to be allocated to base stations, generation of a transmission message for notifying of allocation information, and classification of resources to be allocated to terminals, which are processing according to the present embodiments. The memory 1007 accumulates the radio resource allocation information according to an embodiment, classification information of radio resources to be allocated to terminals, control information necessary for transmission and reception, and downlink signals transmitted from the network. The baseband signal processing unit 1003 performs baseband signal processing. The RF unit 1002 performs a transform process between an analog transmission/reception signal and a baseband signal.

The baseband signal processing unit of the base station has the exemplary configuration of FIG. 14, similarly to the first and second embodiments.

Referring to FIG. 14, the transmitting unit of the baseband signal processing unit 1003 includes a channel encoder 2001, a modulator 2002, a MIMO encoder 2003, power controller 2004, a resource unit mapper 2005, an IFFT unit 2006, and a CPI unit 2007.

The channel encoder 2001 performs error correction coding on transmission data of multiple users from a user i to a user k. The modulator 2002 performs a modulation process. The MIMO encoder 2003 performs a transform process for MIMO. The power controller 2004 adjusts transmission power. The resource unit mapper 2005 performs mapping to resources allocated to each user according to a frequency resource allocation decided by the scheduler 1005. The IFFT unit 2006 performs a transform process of transforming a signal in the frequency domain into a signal in the time domain. The CPI unit 2007 adds a CP. Next, the description will proceed with transmission signal processing when a transmission signal is transmitted to the terminal located in the sector center in the time zone for the sector center defined by the time schedule according to an embodiment, that is, the time zone shared by three base stations.

Referring back to FIG. 22, first, the NW I/F unit 1006 receives a downlink signal transmitted from a network. The memory 1007 connected to the CPU unit 1004 first accumulates the received signal. The scheduler 1005 mounted in the CPU 1004 decides a transmission beam, a modulation and coding scheme, transmission power, and a frequency resource allocation for the received signal, and decides transmission of a signal based on the radio resource allocation that is generated according to the present embodiments and accumulated in the memory 1007. The received signal is processed into a transmission signal according to the decision.

Referring to FIG. 14, the channel encoder 2001 performs error correction coding on transmission data of the user accumulated in the memory 1007 connected to the CPU unit 1004. Then, the modulator 2002 converts the data that has been subjected to the error correction coding into a modulation signal. The modulation signal is a signal having a constellation on an IQ signal plane as in QPSK, 16QAM, or 64QAM. Thereafter, the MIMO encoder 2003 performs MIMO signal processing on the modulation signal, and distributes the processed signal to respective antennas. The power controller 2004 adjusts power of the input signal. The signal having the power controlled by the power controller 2004 is input to the resource unit mapper 2005. The resource unit mapper 2005 maps signals of the respective users to resources allocated to the respective users according to the frequency resource allocation decided by the scheduler 1005. The mapping to the resources is performed for each antenna. The IFFT unit 2006 converts information of each antenna in the frequency domain into a signal in the time domain. The CPI unit 2007 adds a CP to the obtained signal in the time domain, and transmits a baseband transmission signal to the RF unit 1002 of FIG. 15. The RF unit 1002 converts the baseband signal into an RF signal, and transmits the transmission signal through the antenna 1001.

The point of the present embodiments lies in a mechanism in which the amount of information exchanged between base stations is reduced using the efficiency calculated based on the CINR and the RSSI instead of the CINR and the RSSI obtained from the scanning result of the terminal as information exchange between base stations in order to perform interference control, and the radio resources to be allocated for the sector center, the sector edge, and the cell edge are decided using the exchanged efficiency, and thus the load of the base station that performs concentrated control is distributed. The operation of the scheduler that identifies the terminal capable of performing communication for each radio resource such as the R1 resources and performs scheduling according to the radio resource allocation information is within the scope of the present invention.

The exemplary embodiments have been described above, but the present invention is not limited to the above embodiments, and it is obvious to a person skilled in the art that various changes and modifications can be made within the spirit of the present invention and the appended claims.

### REFERENCE SIGNS LIST

1 base station
10 mobile terminal
20 network device
1001 antenna
1002 rf unit
1003 baseband unit
1004 cpu
1005 scheduler
1006 nw/if unit
1007 memory unit
2200 resource calculator
2001 channel encoder
2002 modulator
2003 mimo encoder
2004 power controller
2005 resource unit mapper
2006 ifft unit
2007 cpi unit

1. A cellular wireless communication system in which service areas are configured by arranging multiple base station devices that transmit or receive a radio signal to or from a terminal such that cells formed by the base station devices are adjacent to each other, the system comprising:
multiple base station devices that determine whether a terminal performing communication with a base station device within the service area is located in a cell center or a cell edge, and perform scheduling so that communication with a terminal located in the cell center and communication with the terminal located in the cell edge are performed in different time zones.

2. The wireless communication system according to claim 1, wherein the base station device performs scheduling and performs communication such that multiple base station devices performs communication with the terminal located in the cell center in the same time zone, communication with the terminal located in the cell edge is performed in a time zone different from communication with the terminal located in the cell center, and time zones do not overlap in the cell edge between neighbor base station devices.

3. The wireless communication system according to claim 2, wherein a cell formed by multiple base station devices includes three base station units and is configured with three sectors, and
a time zone in which communication with the terminal located in the cell center includes a time zone in which all the three base station units perform communication with terminals, a time zone in which two of the three base station units perform communication with terminals, and a time zone in which one of the three base station units performs communication with terminals.

4. The wireless communication system according to claim 3,
wherein the cell center is further divided into a sector center, a left sector edge, and a right sector edge based on a position when viewed in a direction from a base station unit to a cell edge,
which of the sector center, the left sector edge, and the right sector edge the terminal located in the cell center is located in is determined, and
the time zone in which all the three base station units perform communication is allocated to communication with the terminal located in the sector center, the time zone in which two of the three base station units perform communication is allocated to communication with a terminal located in either of the left and right sectors edges according to a combination of the sector center and the two base station unit, and the time zone in which one of the three base station units perform communication is allocated to communication of a cell edge terminal which is one of the three base station units.

5. The wireless communication system according to claim 3, wherein an allocation of the time zone is decided by one of three base station units configuring three sectors, and as the decided base station unit notifies the other two base station units of a time zone allocation, the three base station units perform communication in collaboration with one another.

6. The wireless communication system according to claim 4, wherein a position of a terminal is decided based on report information related to the three base station units in the terminal.

7. A wireless communication method in a cellular wireless communication system in which service areas are configured by arranging multiple base station devices that transmit or receive a radio signal to or from a terminal such that cells formed by the base station devices are adjacent to each other, the method comprising:
determining whether a terminal performing communication with multiple base station devices within the service area is located in a cell center or a cell edge; and
performing, by multiple base station devices, communication with a terminal located in the cell center and communication with the terminal located in the cell edge in different time zones.

8. The wireless communication method according to claim 7, wherein communication is performed such that multiple base station devices do not perform communication with the terminal located in the cell center in the same time zone, communication with the terminal located in the cell edge is performed in a time zone different from communication with the terminal located in the cell center, and time zones do not overlap in the cell edge between neighbor base station devices.

9. The wireless communication method according to claim 8,
wherein a cell formed by multiple base station devices includes three base station units and is configured with three sectors, and
a time zone in which communication with the terminal located in the cell center includes a time zone in which all the three base station units perform communication with terminals, a time zone in which two of the three base station units perform communication with terminals, and a time zone in which one of the three base station units performs communication with terminals.

10. The wireless communication method according to claim 9,
wherein the cell center is further divided into a sector center, a left sector edge, and a right sector edge based on a position when viewed in a direction from a base station unit to a cell edge,
which of the sector center, the left sector edge, and the right sector edge the terminal located in the cell center is located in is determined, and
the time zone in which all the three base station units perform communication is allocated to communication with the terminal located in the sector center, the time zone in which two of the three base station units perform communication is allocated to communication with a terminal located in either of the left and right sectors edges according to a combination of the sector center and the two base station unit, and the time zone in which one of the three base station units perform communication is allocated to communication of a cell edge terminal which is one of the three base station units.

11. The wireless communication method according to claim 9, wherein an allocation of the time zone is decided by one of three base station units configuring three sectors, and as the decided base station unit notifies the other two base station units of a time zone allocation, the three base station units perform communication in collaboration with one another.

12. The wireless communication method according to claim 10, wherein a position of a terminal is decided based on report information related to the three base station units in the terminal.

13. A base station, comprising:
multiple antennas;
a radio frequency unit that performs a transform process between a signal to be transmitted or received through the antenna and a baseband signal;
a baseband signal processing unit;
a processor; and
an interface unit with a wired network,
wherein a scheduler mounted in the processor determines whether a terminal performing communication with a base station is located in a cell center configured by the base station or a cell edge, and performs scheduling so that communication with a terminal located in the cell center and communication with the terminal located in the cell edge are performed in different time zones.

14. The base station according to claim 13, wherein scheduling is performed such that multiple base station devices performs communication with the terminal located in the cell center in the same time zone, communication with the terminal located in the cell edge is performed in a time zone different from communication with the terminal located in the cell center, and time zones do not overlap in the cell edge between neighbor base station devices.

15. A cellular wireless communication system in which service areas are configured by arranging multiple base station devices that transmit or receive a radio signal to or from a terminal such that cells formed by the base station devices are adjacent to each other, the system comprising:
multiple neighbor base station devices within the wireless communication system that are classified into one control base station device and multiple second base station devices,
wherein multiple second base station devices and the control base station device include a resource calculator that calculates an index value representing the number of bits transmittable by a unit radio resource for each terminal using communication quality information acquired from terminals that are performing communication with the base station devices,
multiple second base station devices transmit as many index values as the number of terminals to the control base station, and
the control base station device allocates radio resources to multiple neighbor base station devices and the terminals based on the index values of the terminals received from multiple second base station devices, the index values of the terminals of the control base station device, and the number of terminals that are performing communication with the base station devices which are decided based on the number of index values, and notifies the second base station devices of an allocation result.

16. The wireless communication system according to claim 15, wherein the communication quality information acquired from the terminal includes one or two or more of a CINR and an RSSI obtained by scanning of the terminal and a CQI included in report information from the terminal, and
the resource calculator of multiple neighbor base station devices calculates an index value representing the number of bits transmittable by the unit radio resource based on the received quality information of each terminal using a common algorithm.

17. The wireless communication system according to claim 15,
wherein the base station device includes multiple sectors, includes a base station unit for each sector, and classifies multiple base station units into one control base station unit and multiple second base station units,
multiple base station units include a resource calculator,
in multiple neighbor base station devices, radio resource to allocated to the cell edge are fixed, and
for radio resources to be allocated to the cell center, the resource calculator of each base station unit calculates an index value of each terminal in each base station unit and transmits the index value to the control base station unit, and the control base station unit allocates radio resources to multiple base station units in the cell center and the terminals of multiple base station units.

18. The wireless communication system according to claim 17, wherein the resource calculator of the base station unit calculates an index value representing the number of bits transmittable by the unit radio resource based on quality information of each of the terminal using a common algorithm.

19. The wireless communication system according to claim 15, wherein radio resource allocation control in the control base station device or the control base station unit is performed such that radio resources are divided into a frequency axis direction and/or a time axis direction and allocated.

20.-25. (canceled)
